(19) United States
(12) Patent Application Publication
(10) Pub. No.: US 2024/0195772 A1
(43) Pub. Date: Jun. 13, 2024

(54) INFORMATION INTERACTION/PROCESSING METHOD, TAG DELETION METHOD, AND SCHEDULE CREATION METHOD AND DEVICE

(71) Applicant: BEIJING ZITIAO NETWORK TECHNOLOGY CO., LTD., Beijing (CN)

(72) Inventors: Yuhao PAN, Beijing (CN); Liyue ZHAO, Beijing (CN)

(21) Appl. No.: 18/552,299

(22) PCT Filed: Mar. 16, 2022
(86) PCT No.: PCT/CN2022/081127

§ 371 Date: Sep. 25, 2023

(30) Foreign Application Priority Data
Mar. 25, 2021 (CN) 202110321003.5
Mar. 25, 2021 (CN) 202110322528.0
Mar. 25, 2021 (CN) 202110322529.5

(51) Int. Cl. H04L 51/216; G06F 40/166; H04L 51/04; H04L 51/08

(52) U.S. Cl. CPC H04L 51/216; G06F 40/166; H04L 51/04; H04L 51/08

(57) ABSTRACT

Embodiments of the present application disclose an information interaction method: when a user wishes to add tags to a plurality of associated objects, the user only needs to trigger a tag adding operation for one of the objects thereamong. Thus, the number of tag adding operations which the user needs to trigger is reduced, the speed of tag adding is increased, and user operations are simplified. The embodiments of the present application provide a task-based information processing method: a first user may view, on a first page, information of at least one task related thereto, without needing to separately open pages corresponding to each tag, and thus user operation is simple. The present application discloses a schedule creation method: after a user triggers a schedule adding operation in an associated page of a first tag, the first tag is automatically brought into a schedule adding page, and a schedule comprising the first tag may be generated. The user does not need to first create a schedule and then add a tag to the schedule, thereby reducing the tediousness of the operation of creating a schedule having a tag.

The present application is a national stage of International Application No. PCT/CN2022/081127, filed on Mar. 16, 2022, which claims priority to:
1. Chinese Patent Application No. 202110322529.5, titled “INFORMATION INTERACTION METHOD, LABEL DELETING METHOD, AND APPARATUS”, filed on Mar. 25, 2021 with the China National Intellectual Property Administration, which is incorporated herein by reference in its entirety,
2. Chinese Patent Application No. 202110322528.0, titled “TASK-BASED INFORMATION PROCESSING METHOD AND APPARATUS”, filed on Mar. 25, 2021 with the China National Intellectual Property Administration, which is incorporated herein by reference in its entirety, and
3. Chinese Patent Application No. 202110321003.5, titled “SCHEDULE CREATING METHOD AND APPARATUS”, filed on Mar. 25, 2021 with the China National Intellectual Property Administration.

The disclosures of the aforementioned applications are incorporated herein by reference in their entireties.

### FIELD

The present disclosure relates to the computer field, and in particular to an information interaction method, a label deleting method, an information processing method, a schedule-based information processing method, a schedule creating method and apparatus.

### BACKGROUND

With the development of computer and internet technologies, various kinds of applications abound and the functions of the application are increasingly abundant, so as to meet user needs. Currently, a user can send text messages, upload documents to a cloud server, and set schedule reminders through applications, which has brought great convenience to the user in both work and daily life.

With the use of the user, the amount of data increases in the applications, and different types of data are mixed together, making it difficult for the user to find data of a certain type or with certain attribute. Therefore, in some existing technologies, tags can be added to certain objects. For example, tags may be added to objects such as cloud documents, schedules, instant messaging (IM) groups, and instant messaging messages. In this way, the user can quickly find the target object through the label.

However, currently, operations for the user to create an object under a tag or perform corresponding operations on an object with a tag are cumbersome. Therefore, there is an urgent need for a solution to the above problems.

### SUMMARY

An information interaction method, a label deleting method, a schedule creating method, and a schedule-based information processing method and apparatus are provided according to the embodiments of the present disclosure, to solve the problems in the conventional technology.

In a first aspect, an information interaction method is provided according to an embodiment of the present disclosure. The method includes:
receiving a label adding operation triggered by a user for a first object;
generating a first correspondence between a target label and the first object, according to the label adding operation; and
generating a second correspondence between the target label and a second object in response to a generation of the first correspondence, where the second object is associated with the first object.

In a second aspect, a label deleting method is provided according to an embodiment of the present disclosure. The method includes:
receiving a label deleting operation triggered by a user for a first object;
deleting a first correspondence between a target label and the first object, according to the label deleting operation; and

deleting a second correspondence between the target label and a second object in response to a deletion of the first correspondence, where the second object is associated with the first object.

In a third aspect, an information interaction apparatus is provided according to an embodiment of the present disclosure. The apparatus includes:
a receiving module configured to receive a label adding operation triggered by a user for a first object;
a first generating module configured to generate a first correspondence between a target label and the first object according to the label adding operation: and
a second generating module configured to generate a second correspondence between the target label and a second object in response to a generation of the first correspondence, where the second object is associated with the first object.

In a fourth aspect, a label deleting apparatus is provided according to an embodiment of the present disclosure. The apparatus includes;
a receiving module configured to receive a label deleting operation triggered by a user for a first object;
a first deleting module configured to delete a first correspondence between a target label and the first object, according to the label deleting operation;
a second deleting module configured to delete a second correspondence between the target label and a second object in response to a generation of the first correspondence, where the second object is associated with the first object.

In a fifth aspect, a task-based information processing method is provided according to an embodiment of the present disclosure. The method includes:
obtaining at least one task that is associated with a first user and that has a label, where the label is an additional attribute of the at least one task, and is shared within a preset range determined by a permission for the label;
displaying information corresponding to the at least one task on a first page, where the first page is displayed on a client logging in to an account of the first user.

In a sixth aspect, an information processing method is provided according to an embodiment of the present disclosure. The method includes:
displaying a first information adding page in response to an information adding operation triggered by a user for a first information field, wherein the first information adding page includes identifiers of multiple information fields, and the multiple information fields include a first information field and a second information field;
displaying candidate information corresponding to the second information field in response a selecting operation triggered by the user for the identifier of the second information field, wherein the second information field is different from the first information field; and
generating, in response to a selecting operation triggered by the user for at least one piece of information in the candidate information, an association relationship between the at least one piece of information and a first label.

In a seventh aspect, a task-based information processing apparatus is provided according to an embodiment of the present disclosure. The apparatus includes:
a first obtaining unit configured to obtain at least one task that is associated with a first user and that has a label, where the label is an additional attribute of the at least one task, and is shared within a preset range determined by a permission for the label: and
a first display unit configured to display information corresponding to the at least one task on a first page, where the first page is displayed on a client logging in to an account of the first user.

In an eighth aspect, an information processing apparatus is provided according to an embodiment of the present disclosure. The apparatus includes:
a first display unit configured to display a first information adding page in response to an information adding operation triggered by a user for a first information field, wherein the first information adding page includes identifiers of multiple information fields, and the multiple information fields include a first information field and a second information field;
a second display unit configured to display candidate information corresponding to the second information field in response a selecting operation triggered by the user for the identifier of the second information field, wherein the second information field is different from the first information field; and
a first generating unit configured to generate, in response to a selecting operation triggered by the user for at least one piece of information in the candidate information, an association relationship between the at least one piece of information and a first label.

In a ninth aspect, a schedule creating method is provided according to an embodiment of the present disclosure. The method includes:
displaying a schedule adding page in response to a schedule adding operation triggered by a user on a page associated with a first label, where the schedule adding page includes the first label, and the page associated with the first label is configured to present associated information of the first label: and
obtaining schedule information inputted by the user on the schedule adding page, and generating a schedule with the first label.

In a tenth aspect, a schedule creating method is provided according to an embodiment of the present disclosure. The method includes:
displaying a schedule adding page in response to a schedule adding operation triggered by a user on a page associated with a first label, where the schedule adding page includes the first label, and the page associated with the first label is configured to present information associated with the first label;
modifying the first label to a second label in response to a label editing operation triggered by the user on the schedule adding page: and
obtaining schedule information inputted by the user on the schedule adding page, and generating a schedule with the second label.

In an eleventh aspect, a schedule creating apparatus is provided according to an embodiment of the present disclosure. The apparatus includes:
a display unit configured to display a schedule adding page in response to a schedule adding operation triggered by a user on a page associated with a first label, where the schedule adding page includes the first label, and the page associated with the first label is configured to present information associated with a label;
a first obtaining unit configured to obtain schedule information inputted by the user on the schedule adding page: and a generating unit configured to generate a schedule with the first label.

In a twelfth aspect, a schedule creating apparatus is provided according to an embodiment of the present disclosure. The apparatus includes:
a first display unit configured to display a schedule adding page in response to a schedule adding operation triggered by a user on a page associated with a first label, wherein the schedule adding page includes the first label, and the page associated with the first label is configured to present information associated with the first label;
a modifying unit configured to modify the first label to a second label in response to a label editing operation triggered by the user on the schedule adding page;
an obtaining unit configured to obtain schedule information inputted by the user on the schedule adding page, and a generating unit configured to generate a schedule with the second label.

In a thirteen aspect, a device is provided according to an embodiment of the present disclosure. The device includes a processor and a memory.

The processor is configured to execute instructions stored in the memory, to cause the device to perform the method according to any one of the first aspect, the second aspect, the fifth aspect, the sixth aspect, the ninth aspect, or the tenth aspect.

In a fourteenth aspect, a computer-readable storage medium is provided according to an embodiment of the present disclosure. The computer-readable storage medium includes instructions, where the instructions instruct a device to perform the method according to any one of the first aspect, the second aspect, the fifth aspect, the sixth aspect, the ninth aspect, or the tenth aspect.

In a fifteenth aspect, a computer program product is provided according to an embodiment of the present disclosure. The computer program product, when run on a computer, causes the computer to perform the method according to any one of the first aspect, perform the method according to any one of the second aspect, perform the method according to any one the first aspect, the second aspect, the fifth aspect, the sixth aspect, the ninth aspect, or the tenth aspect.

In the information interaction method according to the embodiments of the present disclosure, the first correspondence may be generated according to the label adding operation triggered by the user for the first object, and the second correspondence may be automatically generated in response to the generation of the first correspondence. That is, a label may be added to the first object, and the label may be automatically added to the second object based on the action of adding the label to the first object. In this way, based on an operation triggered by a user for adding a label to a single object, the same label may be automatically added to other objects associated with the object, instead of adding the label to each object separately. In this case, when the user wants to add a label to multiple associated objects, the user only needs to trigger the label adding operation for one of the objects. Thus, the number of label adding operations to be triggered by the user is reduced, the speed of adding the label is increased, and the user can obtain a better experience.

A task-based information processing method is provided according to the embodiments of the present disclosure. In an example, the client may obtain at least one task that is related to the first user and has a label. The label is an additional attribute of the at least one task, and the label may be shared within a preset range determined by a permission for the label. After the at least one task is obtained, information corresponding to the at least one task may be displayed on the first page displayed on the client. With this solution, the first user may view information of at least one task related to the user on the first page without opening pages respectively corresponding to labels, which makes the user operation simple and improves the efficiency of the user to view tasks related to the user.

An information processing method is provided according to an embodiment of the present disclosure. In an example, the user may trigger an information adding operation for a first information field. After the user triggers the information adding operation, the client may display a first information adding page in response to the operation. The first information adding page includes identifiers of multiple information fields, and the multiple information fields include a first information field and a second information field. In this case, the user may trigger a selecting operation for an identifier of the second information field, and the client may display candidate information corresponding to the second information field in response to the selecting operation triggered by the user for the identifier of the second information field. The second information field mentioned here is different from the first information field. Further, the user may trigger a selecting operation for at least one piece of information in the candidate information, and the client may generate an association relationship between the at least one piece of information and the first label in response to the selecting operation triggered by the user for the at least one piece of information in the candidate information. With this solution, even if the user triggers an information adding operation for the first information field on the overview page of the first label, the information of the second information field with the first label can also be added.

A schedule creating method is provided according to the embodiments of the present disclosure. A user may trigger a schedule adding operation on a page which is associated with a first label and is displayed on a client, and the client may respond to the schedule adding operation to display a schedule adding page. The schedule adding page includes the first label. The page associated with the first label is configured to present information associated with the first label. After the schedule adding page is displayed, the user may input schedule information on the schedule adding page, and the client may obtain the schedule information, and further generate a schedule with the first label based on the schedule information. With this solution, after the user triggers the schedule adding operation on the page associated with the first label, the first label may be automatically brought into the schedule adding page. Further, the schedule with the first label may be generated, rather than a process of the user creating a schedule and then adding the first label to the schedule. Thus, the cumbersome operation for creating a schedule with a label is reduced.

A schedule creating method is provided according to the embodiments of the present disclosure. A user may trigger a schedule adding operation on a page which is associated with a first label and is displayed on a client, and the client may respond to the schedule adding operation to display a schedule adding page. The schedule adding page includes the first label. The page associated with the first label is configured to present information associated with the first label. After the schedule adding page is displayed, the user may trigger a tag editing operation on the schedule adding page, to modify the first label on the schedule adding page to a second label. Then, the user may input schedule information on the schedule adding page, and the client may obtain the schedule information, and further generate a schedule with the second label based on the schedule information. With this solution, when the user wants to create the schedule with the second label, even if a page displayed on the client is the page associated with the first label, the user does not need to switch the page displayed on the client to a page associated with the second label, and the schedule with the second label may be directly created on the page associated with the first label, thereby improving the operational flexibility of creating a schedule with a label.

### BRIEF DESCRIPTION OF THE DRAWINGS

The drawings to be used in the description of the embodiments of the present disclosure or the conventional technology will be described briefly as follows, so that the technical solutions according to the embodiments of the present disclosure or according to the conventional technology will become clearer. It is apparent that the drawings in the following description only illustrate some embodiments of the present disclosure. For those skilled in the art, other drawings may be obtained according to these drawings without any creative work.

FIG. 1 is a flowchart of an information interaction method according to the present disclosure:

FIG. 2 is a schematic diagram of a display interface of a client according to an embodiment of the present disclosure:

FIG. 3 is a schematic diagram of a display interface of a client according to another embodiment of the present disclosure:

FIG. 4 is a schematic diagram of a display interface of a client according to another embodiment of the present disclosure:

FIG. 5 is a schematic diagram of a display interface of a client according to another embodiment of the present disclosure:

FIG. 6-a is a schematic diagram of a display interface of a client according to another embodiment of the present disclosure:

FIG. 6-b is a schematic diagram of a display interface of a client according to another embodiment of the present disclosure:

FIG. 6-c is a schematic diagram of a display interface of a client according to another embodiment of the present disclosure:

FIG. 6-d is a schematic diagram of a display interface of a client according to another embodiment of the present disclosure:

FIG. 7 is a flow chart of a label deleting method according to an embodiment according to the present disclosure:

FIG. 8 is a flow chart of a label deleting method according to another embodiment of the present disclosure:

FIG. 9 is a schematic structural diagram of an information interaction apparatus according to an embodiment of the present disclosure;

FIG. 10 is a schematic structural diagram of a label deleting apparatus according to an embodiment of the present disclosure:

FIG. 11 is a schematic structural diagram of an electronic device according to an embodiment of the present disclosure.

FIG. 12 is a flow chart of a task-based information processing method according to an embodiment of the present disclosure;

FIG. 13 is a schematic diagram of a first page according to an embodiment of the present disclosure:

FIG. 14 is a flow chart of an information processing method according to an embodiment of the present disclosure;

FIG. 15a is a schematic diagram of an overview page of a first label according to an embodiment of the present disclosure:

FIG. 15b is a schematic diagram of an information adding page according to an embodiment of the present disclosure;

FIG. 15c is a schematic diagram of an information adding page according to another embodiment of the present disclosure:

FIG. 16 is a schematic structural diagram of a task-based information processing apparatus according to an embodiment of the present disclosure;

FIG. 17 is a schematic structural diagram of an information processing apparatus according to an embodiment of the present disclosure.

FIG. 18 is a flow chart of a schedule creation method according to an embodiment of the present disclosure:

FIG. 19 is a schematic diagram of a schedule adding page according to an embodiment of the present disclosure:

FIG. 20 is a flow chart of a schedule creation method according to another embodiment of the present disclosure:

FIG. 21 is a schematic structural diagram of a schedule creating apparatus according to an embodiment of the present disclosure: and

FIG. 22 is a schematic structural diagram of a schedule creating apparatus according to another embodiment of the present disclosure.

### DETAILED DESCRIPTION OF EMBODIMENTS

Embodiments of the present disclosure will be described in more detail below with reference to the accompanying drawings. While certain embodiments of the present disclosure are shown in the drawings, it should be understood that the present disclosure may be embodied in various forms and should not be construed as limited to the embodiments set forth herein. Instead, the embodiments are provided for the purpose of a more thorough and complete understanding of the present disclosure. It should be understood that the drawings and embodiments of the present disclosure are only for exemplary purposes, and are not intended to limit the scope of the present disclosure.

It should be understood that the various steps described in the method embodiments of the present disclosure may be performed in different orders and/or in parallel. Furthermore, method embodiments may include additional steps and/or omit performing the illustrated steps. The scope of the present disclosure is not limited in this regard.

As used herein, the term “including” and variations thereof are open-ended inclusions, that is, “including but not limited to”. The term “based on” means “based at least in part on.” The term “one embodiment” means “at least one embodiment”: the term “another embodiment” means “at least one additional embodiment”: the term “some embodiments” means “at least some embodiments”. Relevant definitions of other terms will be given in the description below:

It should be noted that concepts such as “first” and “second” mentioned in the present disclosure are only used to distinguish different devices, modules or units, and are not used to limit the order or interdependence of functions performed by these devices, modules or units.

It should be noted that the modifications of “a” and “a plurality” mentioned in the present disclosure are illustrative rather than restrictive, and those skilled in the art should understand that unless the context clearly indicates otherwise, they should be understood as “one or multiple”.

Currently, to facilitate management and search, some applications have a label adding function. A user may add a label to an object such as a message and a cloud file, through a label adding operation. In this way, the user can search for the object such as the message or the cloud file through the label.

When adding a label, the user may trigger the label adding operation for a target object to be added with a label. For example, the label adding operation may be triggered by clicking a label adding control corresponding to the target object. After receiving the label adding operation triggered by the user, the client may determine the target label according to the label adding operation, and generate a correspondence between the target object and the target label, so as to add the target label to the target object. In this way, a label may be added to the target object based on the label adding operation. Thus, the user can flexibly manage the target object. However, existing label adding methods need to trigger the label adding operation for each target object. When the number of target objects be added with labels is large, the user needs to trigger the label adding operation for each target object, which obviously increases the amount of user's operations, and reduces the speed of adding labels.

In addition, when deleting the target label of the target object, the user can trigger the label deleting operation for one target object at a time. When the target labels of multiple target objects need to be deleted, the user needs to trigger the label deleting operation for each of the multiple target objects. Although the user can also directly delete the target label, the operation for deleting the target label will delete all target objects with the target labels, and cannot delete a part of target objects with the target labels.

In order to solve the problems in the conventional technology, an information interaction method and a label deleting method are provided according to the embodiments of the present disclosure, which will be described in detail below with reference to the accompanying drawings.

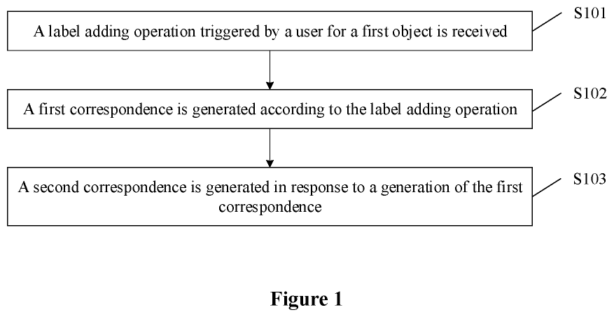

FIG. 1 is a flow chart of an information interaction method according to an embodiment of the present disclosure. This embodiment is applicable to a scene of adding a label to a first object and a second object that are associated with each other. The method may be implemented by a label adding processing apparatus. The apparatus may be implemented by software and/or hardware, and integrated into a client of the user. The client may be integrated into a PC (Personal Computer) or a mobile terminal. Of course, the information interaction method (including the label deleting method described later) according to the embodiments of the present disclosure may also be executed by a computer device such as a server. The method being executed by the client is described below as an example for illustration. As shown in FIG. 1, the method includes the following steps S101 to S103.

In step S101, a label adding operation triggered by a user for a first object is received.

In an embodiment of the present disclosure, the first object may be any one of objects such as a cloud file, a local file, a folder, a schedule, a task, an instant messaging message, and an instant messaging group. That is, the user may trigger the label adding operation for each of the above objects. The second object described below may be any object associated with the first object, which may be any one of objects such as a cloud file, a local file, a folder, a schedule, a task, an instant messaging message, and an instant messaging group. The cloud file may be a file stored in a server. For example, it may be a cloud document, that is, a file document stored in the server. Alternatively, the cloud file may be a cloud video, that is, a video file stored in the server. The user may download the cloud file from the server to the local, or may also open (for example, open in a web browser) the cloud file by accessing the storage address of the cloud file in the server. The local file is a document stored locally on the client. Similarly, the folder may be a folder for a cloud file or a folder for a local file.

The instant messaging message is a message that is sent or received by a user through an instant messaging application. The instant messaging message includes a group chat instant messaging message and a private chat instant messaging message. The group chat instant messaging message is a message sent by an instant messaging user in an instant messaging group. The private chat instant messaging message is a message sent by an instant messaging user to another instant messaging user through a private chat. The instant messaging group includes at least three instant messaging users, and messages sent in the instant messaging group is viewable by any instant messaging user in the group. In the private chat, a message may be sent between two instant messaging users and cannot be seen by the third instant messaging user.

In an embodiment of the present disclosure, the label adding operation may be a sliding operation, or an operation triggered on a label adding control. For example, the label adding operation may be an operation of clicking on a label adding control. The sliding operation refers to a sliding trajectory on a screen that is triggered by the user and obtained by the client. When the screen of the client is a non-touch screen, the sliding operation may be an operation that the user controls a movement of a cursor or a mouse on the screen through an external device (such as a mouse, a tablet, etc.) to generate a sliding trajectory. When the screen of the client is a touch screen, the sliding operation may be an operation that the user moves a finger on the screen to generate a sliding trajectory.

When the sliding trajectory is a preset trajectory, it may be determined that a label adding operation is triggered by the user. For example, it is assumed that the screen of the client is a touch screen and the preset trajectory is a circle. The client may record the sliding trajectory of the user's finger. If it is detected that the sliding trajectory is a circle, it may be determined that the label adding operation is triggered by the user.

The label adding control is configured to trigger a label adding operation. When the user triggers the label adding control, for example, by clicking or long pressing the label adding control, the client may determine that the user triggers the label adding operation. The user may trigger the label adding operation for the first object on an interface for displaying the first object, or trigger the label adding operation for the first object on a label display interface for displaying a label. The label display interface will be described in detail in the following, and is not introduced in detail here.

In step S102, a first correspondence is generated according to the label adding operation.

After the label adding operation triggered by the user for the first object is received, the first correspondence may be generated according to the label adding operation. The first correspondence is between the first object and the target label. The target label is a label that is to be added by the user to the first object.

In an embodiment of the present disclosure, the first object may be any one of operation objects on which a label can be added, such as a folder, a cloud file, a local file, a schedule, a task, an instant messaging message, and an instant messaging group. Correspondingly, the second object described later may be any one of the above-mentioned objects that is associated with the first object.

Before the first correspondence is generated, the target label may be determined according to the label adding operation. In an embodiment of the present disclosure, the target label may be created by the user that triggers the label adding operation, or may be created by a user other than the user that triggers the label adding operation. Before the target label is obtained, it may be determined whether the user has a permission to add the target label to the first object. For example, it is assumed that a user A has created a label X, and a user B has a permission to add the label X. Then, when the user B is to add the label X to the first object, it may be determined that the user B has the permission to add the label X, so as to add the label X to the first object.

In order to obtain the target label, multiple addible candidate labels may be presented. After the label adding operation is triggered, the user may perform a selecting operation on a target label to be added, that is, select one or more labels from the candidate labels as the target label. Correspondingly, the selecting operation triggered by the user may be received after the label adding operation triggered by the user is received, to determine the target label according to the user's requirement and add the target label to the first object. In an embodiment of the present disclosure, the at least one displayed candidate label may be arranged according to a preset rule. The preset rule may include one or more of label creation time, label access time, and a matching degree with a keyword. The candidate label may include a label created by the user and a label created by another user. The keyword may be inputted by the user in a label searching box.

After the target label is determined according to the label adding operation, the correspondence between the first object and the target label may be generated, and the target label may be added to the first object.

In some possible implementations, the first correspondence may further include a correspondence between the target label and an information block (Block) of the first object. Similarly, the second correspondence may include a correspondence between the target label and an information block of the second object. The information block is generated based on an object, such as, the first object or the second object. In an embodiment, the information block of the first object may include summary information of the first object, which is used to briefly describe the first object. The information block of the second object may include summary information of the second object, which is used to briefly describe the second object. For example, if the second object is a cloud document in a cloud file, the information block of the second object may include summary information of the cloud document. The summary information of the cloud document may include information, such as, a title, an author and a release time, of the cloud document. If the second object is an instant messaging message, the summary information of the second object may be a sender of the instant messaging message and the first n characters of the instant messaging message, where n is an integer greater than or equal to 1.

The information block may further include presentation information of the object, such as, the first object or the second object. The presentation information is used to present the object. For example, if the first object is a cloud file, the presentation information of the first object may include a link of the cloud file, through which entire content of the cloud file may be displayed. If the first object is an instant messaging message, the presentation information of the first object may include entire content of the instant messaging message (without opening the instant messaging application window) corresponding to the target label; or include a link for calling the instant messaging message, through which the entire content of the instant messaging message corresponding to the target label may be displayed in the instant messaging application window.

Similar to the first correspondence, the second correspondence described later may include a correspondence between the target label and an information block of the second object.

In step S103, a second correspondence is generated in response to a generation of the first correspondence.

After the first correspondence is determined to be generated, the second correspondence may be generated, according to the generation of the first correspondence or according to the label adding operation triggered by the user for the first object. The second correspondence is between the second object and the target label. The second object is an object associated with the first object. That is, after the label adding operation for adding the target label to the first object is received, the target label may be automatically added to the second object associated with the first object according to the label adding operation.

The second object will be introduced in detail below.

The second object is an object associated with the first object, for example, another object belonging to the first object, or another object generated on the basis of the first object. For example, assuming that the first object is a folder, the second object may be a subfolder or a document in the folder. That is, the second object is another object belonging to the first object. Assuming that the first object is an instant messaging group, the second object may be a message (for example, a message in the instant messaging group that is concerned by group members in a certain way) or a document sent by a user in the instant messaging group. That is, the second object is another object generated on the basis of the first object.

In an embodiment of the present disclosure, the second object may be a historically associated object obtained by the client or the server before receiving the label adding operation, or may be a new object obtained by the client or the server after receiving the label adding operation. These two situations will be introduced respectively below.

In a first possible implementation, the second object is the historically associated object obtained by the client or the server before receiving the above label adding operation triggered by the user for the first object. That is, the client or the server first obtains the second object, and then receives the label adding operation. After the second object is obtained, the association relationship between the first object and the second object may be recorded. After the label adding operation triggered by the user for the first object is received, the stored association relationship may be searched for to determine the second object associated with the first object. Then, the second correspondence between the second object and the target label is generated, to add the label to the second object.

The first object being an instant messaging group A, and the second object being a group chat instant messaging message B are taken as an example for illustration. After receiving the group chat instant messaging message B through the instant messaging group A, the client may record the association relationship between the group chat instant messaging message B and the instant messaging group A. Then, after receiving the label adding operation triggered by the user for the instant messaging group A, the client may search for the group chat instant messaging message B associated with the instant messaging group A according to a recorded association relationship, generate a correspondence between the target label and the group chat instant messaging message B, and add the target label to the group chat instant messaging message B. In this process, it is no need to manually add the target label to the group chat instant messaging message B by the user.

In a second possible implementation, the second object is a new associated object obtained by the client or the server after receiving the label adding operation. That is, the client or the server receives the label adding operation first, and then obtains the second object. In this case, after the label adding operation is received, the label adding operation may be recorded. After the second object is obtained, the correspondence between the second object and the target label may be generated according to the recorded label adding operation, and the label may be added to the second object.

Similarly, the first object being the instant messaging group A, and the second object being the group chat instant messaging message B are taken as an example for illustration. After receiving the label adding operation triggered by the user for the instant messaging group A, the client may record the label adding operation. Then, if a new group chat instant messaging message B is received through the instant messaging group A, the client may determine that the group chat instant messaging message B is associated with the instant messaging group A, and generate the second correspondence between the group chat instant messaging message B and the target label according to the recorded label adding operation, to add the target label to the group chat instant messaging message B.

Before generating the second correspondence, the client or the server may first determine that the user has triggered to enable an automatic label adding function. Enabling automatic label adding function indicates that the user allows the client or the server to add a label to the second object according to the label adding operation for the first object. That is, when the automatic label adding function is enabled, the first correspondence may be generated according to the label adding operation, and the target label may be automatically added to the second object based on the generation of the first correspondence. When the automatic label adding function is disabled, only the first correspondence may be generated according to the label adding operation, and the second correspondence is not generated based on the first correspondence.

In some possible implementation manners, the user may enable or disable the automatic label adding function by performing a trigger operation on an operation control. For example, the client may present a first control to the user, and the first control is configured to enable or disable the automatic label adding function. If it is detected that the user triggers the first control, the automatic label adding function may be enabled (or disabled).

In the foregoing introduction, the target label may be created by the user who triggers the label adding operation, or may be created by the other user different from the user who triggers the label adding operation. Then, before the second correspondence is generated, it may be determined whether the user who triggers the label adding operation has a permission to add a label to the second object. In the case that the user has the permission to add a label to the second object, the second correspondence may be generated. In the case that the user does not have the permission to add the label to the second object, even if the first object and the second object are associated with each other, and the label adding operation has been performed on the first object, the target label is not automatically added to the second object.

In addition, in some possible implementations, before the second correspondence is generated, it may be determined whether a user set indicated by the first object has a capability to add a label to the second object. For example, the client may determine whether the user set indicated by the first object has a permission to access the second object. In the case that the user set indicated by the first object has not the permission to access the second object, the user set corresponding to the first object may not be able to view or edit the second object. In this case, the client may not generate the second correspondence. On the contrary, in the case that the user set indicated by the first object has the permission to access the second user, the client may generate the second correspondence. It should be noted that the user set indicated by the first object is a whole. That is, even if one or more users in the user set indicated by the first object have the permission to access the second object, the user set indicated by the first object may still not have the permission to access the second object.

For example, it is assumed that the first object is an instant messaging group, and the second object is a cloud file sent to the instant messaging group. After the target label is added to the instant messaging group and before the target label is added to the cloud file, it may be determined whether the user set corresponding to the instant messaging group has the permission to access the cloud file. If the user set corresponding to the instant messaging group has the permission to access the cloud file, a correspondence between the cloud file and the target label may be generated, and the target label may be added to the cloud file.

In an embodiment of the present disclosure, the client or the server automatically generate the first correspondence and the second correspondence according to the label adding operation triggered for the first object. That is, the target label of the first object is manually added by the user, and the target label is automatically added to the second object. Then, in order to distinguish between an automatically added label and a manually added label, a label type of the target label in the second correspondence may be set to an automatic addition type, which indicates that the target label of the second object is added automatically, and is not added according to a label adding operation for the second object. The function of the label type may refer to the introduction in the embodiment shown in FIG. 7 in the following, and no repeated description is made here.

After the second correspondence is generated, if a label adding operation for adding the target label to the second object is received, since the correspondence between the second object and the target label has already been generated, a new correspondence may not be generated, but the label type of the target label in the second correspondence is changed to a manual addition type.

After the second correspondence is generated, the client may display prompt information, for indicating completion of adding the target label to the first object and the second object. After viewing the prompt message, the user may be informed that target label has been added to the first object and the second object. In an embodiment, the prompt message may be an icon or a notification message.

In an embodiment of the present disclosure, after the first correspondence or the association relationship between the first object and the second object is released, the client may correspondingly release the second correspondence. The detailed description of this part may refer to the introduction of the embodiment shown in FIG. 7 in the following, and no repeated description is made here.

In the information interaction method according to the embodiments of the present disclosure, the first correspondence may be generated according to the label adding operation triggered by the user for the first object, and the second correspondence may be automatically generated in response to the generation of the first correspondence. That is, a label may be added to the first object, and this label may be automatically added to the second object based on the action of adding the label to the first object. In this way, based on an operation triggered by a user for adding a label to a single object, the same label may be automatically added to other objects associated with the object, instead of adding the label to each object separately. In this case, when the user wants to add a label to multiple associated objects, the user only needs to trigger the label adding operation for one of the objects. Thus, the number of label adding operations to be triggered by the user is reduced, the speed of label adding is increased, and the user can obtain a better experience.

In an embodiment of the present disclosure, the first object and the second object may be objects in a project that are collaboratively processed by multiple users. For example, it is assumed that a user A, a user B, and a user C collaborate on a project X, and create an instant messaging group Y for the project X, and a cloud file Z is sent in the instant messaging group Y. When any one of the user A, the user B and the user C adds a target label M to the instant messaging group Y, the client or server may generate a correspondence between the instant messaging group Y and the target label M, and automatically add the target label M to the cloud file Z based on the generation of the correspondence. Then, other users in the instant messaging group Y can see that the instant messaging group Y has the target label M, and can also see that the cloud file has the target label M. In this way, during project collaboration, based on the label adding operation triggered by the user on one object, a label may be automatically added to one or more associated objects besides the object in the project.

In addition, each of the first object and the second object may be any one of a folder, a cloud file, a local file, a schedule, a task, an instant messaging message, and an instant messaging group. That is, the user may add the same label to objects of different label fields, and may view objects belonging to different label fields of the label. In this way, cross-label field allocation of a label is realized, and the flexibility of management is improved. The label fields will be described in detail in the following, which will not be introduced herein.

Further, the first correspondence and/or the second correspondence in an embodiment of the present disclosure may further include a correspondence between a label and an information block. In this way, compared with the traditional collection method, information such as the summary information of the object may be displayed to the user according to the label and the information block of the object. In this way, the amount of information viewable by the user is increased, so that the user can find the desired object faster.

That is, in an embodiment of the present disclosure, different objects belonging to different label fields may be extracted as information blocks, and a correspondence between the information block and the label may be generated. In this way, extracting objects of different label fields to obtain information blocks solve heterogeneous information entities, homogeneous modeling and labeling consistency in a case of cross-business application and cross-business field circulation, and support cross-business information aggregation and secondary consumption scene. That is, forming information block is to encapsulate objects from different label fields (i.e., heterogeneous information entities). Thus, in the operation of adding a label, different structures of the content of different fields are not taken into consideration, and a unified label adding operation is performed. If no encapsulation is performed, heterogeneous entities in different fields require relatively high integration costs if there is no homogeneous solution.

After the second correspondence (or the first correspondence) is generated, the user may operate on the label of the second object. For example, the user may trigger a label deleting operation for the second object, to control the client or the server to delete the second correspondence. The user may trigger a label editing operation for the second object. After the label editing operation is received, the target object in the second correspondence may be modified according to the label editing operation. In addition, the user may trigger a label adding operation for the second object. A new target label may be determined according to a label adding operation triggered by the user for the second object and a third correspondence may be generated, where the third correspondence is a correspondence between the new target label and the second object.

The above process will be introduced below by taking the first object being an instant messaging group “Work communication group” and the second object being a cloud file A, and the above process be executed by the client as an example.

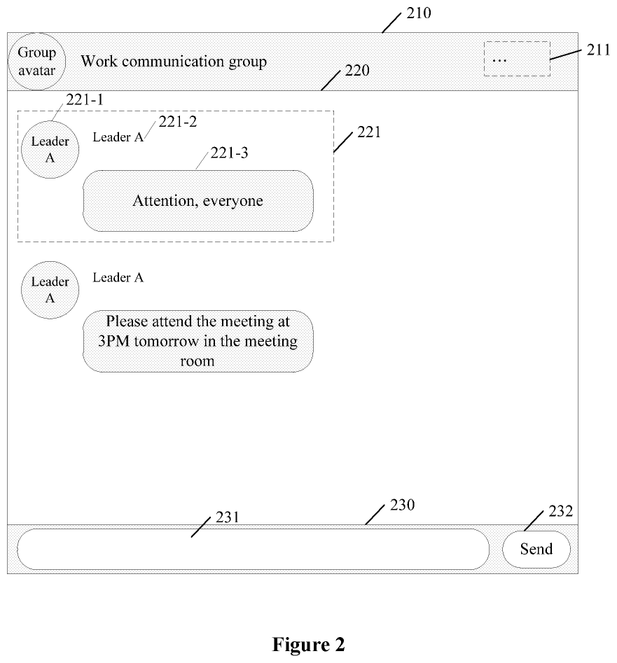

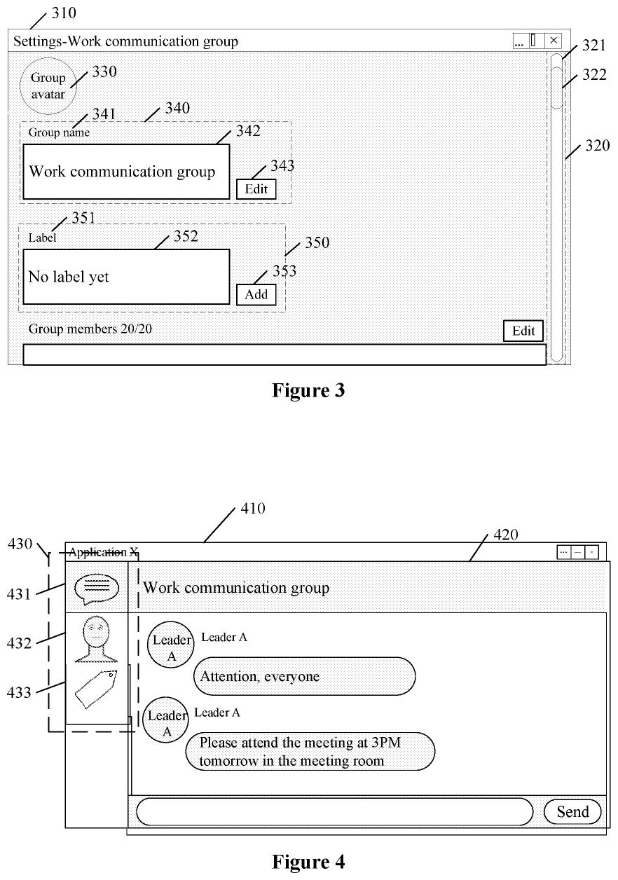

When a user views a group chat instant messaging message on the client, the client may display the group chat instant messaging message and related information of the instant messaging group. As shown in FIG. 2, when the client displays a group chat instant messaging message, the display area may include a title display area 210, a message display area 220 and an operation area 230. The title display area 210 is configured to display basic information of the instant messaging group. For example, in the embodiment shown in FIG. 2, the title display area 210 displays a group name “work communication group” and a group avatar of the instant messaging group. In an embodiment, the title display area 210 may further include a jump control 211 configured to control the client to jump to another interface, for example, jump to an interface for displaying a label adding control, that is, the interface shown in FIG. 3.

The message display area 220 may be configured to display group chat instant messaging messages. In an embodiment, the client may display the message text and the corresponding user information together when displaying the group chat instant messaging message. For example, in the embodiment shown in FIG. 2, the group chat instant messaging message 221 includes an avatar display area 221-1, an identification display area 221-2 and a text display area 221-3. The avatar display area 221-1 is configured to display an avatar of a user who sends the group chat instant messaging message. The identification display area 221-2 is configured to display an identification of the user who sends the group chat instant messaging message. For example, the identification display area 221-2 may be an ID or nickname of the user. The text display area 221-3 is configured to display a text of the group chat instant messaging message sent by the user. In the embodiment shown in FIG. 2, the text of the group chat instant messaging message 221 is “Attention, everyone”.

The operation area 230 may include an input box 231 and a sending control 232. The input box 231 is configured for inputting a group chat instant messaging message. The sending control 232 is configured for sending the group chat instant messaging message to be sent in the input box 231.

In the case that the first object is an instant messaging group, the user may trigger a label adding operation for the first object through the label adding control. In an embodiment, the client may display the label adding control in an interface of the instant messaging group (for example, an interface for displaying the group chat instant messaging messages), or may jump to another interface based on a jump operation triggered by the user and display the label adding control in that interface. In the embodiment shown in FIG. 2, the chat interface of the instant messaging chat group does not include the label adding control for adding a label to the group. The user may click the jump control 211 to control the client to display a setting interface of the instant messaging group. The setting interface includes the label adding control for triggering the label adding operation.

As shown in FIG. 3, when the setting interface of the instant messaging group is displayed, the display area of the client may include a title display area 310, a position adjustment control 320, an avatar adjustment control 330, a name adjustment control 340 and a label adding control 350.

The title display area 310 is configured to display basic information and a basic operation control of the setting interface. For example, in the embodiment shown in FIG. 3, the title display area 310 shows that a name of the setting interface is “settings-work communication group”. The name indicates that the setting interface is used to set related information of the instant messaging group named as “work communication group”.

The position adjustment control 320 is configured to adjust a relative position of the current interface and the display area 300. As shown in FIG. 3, the position adjustment control 320 includes a sliding slot 321 and a slider control 322. The slider control 322 is capable of moving up and down in the sliding slot 321, so as to adjust the relative position of the setting interface and the display area 300.

The avatar adjustment control 330 may be configured to display the avatar of the instant messaging group, and may also be used to modify the avatar of the instant messaging group. For example, when the user wants to modify the avatar of the instant messaging group “work communication group”, the user may click at a position of the avatar adjustment control 330 on the client screen, thereby triggering an avatar replacement operation to modify the avatar of the instant messaging group.

The name adjustment control 340 may be configured to display the name of the instant messaging group, and may also be used to modify the name of the instant messaging group. As shown in FIG. 3, the name adjustment control 340 includes annotation information 341, a name display area 342 and an edit control 343. The annotation information 341 is used to prompt a user that content displayed in the name display area 342 is the name of the instant messaging group. The name display area 342 is configured to display the name of the instant messaging group. The edit control 343 is configured to trigger a name changing operation. For example, when the user wants to modify the group name of the instant messaging group “work communication group”, the user may click the edit control 343 in the name adjustment control 340) on the client screen to trigger the name changing operation, to modify the name of the instant messaging group.

The label adding control 350 may be used to add a label to the instant messaging group, may be further used to display the label corresponding to the instant messaging group, and adjust the label corresponding to the instant messaging group. As shown in FIG. 3, the label adding control 350 includes annotation information 351, a label display area 352 and a label adding control 353. The annotation information 351 is used to prompt the user that content displayed in the label display area 352 is the label corresponding to the instant messaging group. The label display area 352 is used to display the label corresponding to the instant messaging group. In an embodiment, when the instant messaging group has no label, the label display area 342 may display “No label yet”. The label adding control 353 may be configured to trigger the label adding operation. In an embodiment, in the case that the instant messaging group has a label, the label adding control 353 may further be configured to trigger a label deleting operation or a label changing operation.

In some possible implementations, the label adding control 353 may include an indication message, for prompting the user that the label adding control 353 may be used to trigger a label adding operation, or that the label adding control 353 may be used to trigger a label deleting operation or a label changing operation. For example, in the case that the instant messaging group has no label, the indication message of the label adding control 353 may be “add”, for prompting the user that the label adding control 353 may be used to trigger the label adding operation. In the case that the instant messaging group has a label, the indication message of the adding control 353 may be “add”, which is used to prompt the user that the label adding control 353 may be used to trigger the label adding operation, the label changing operation or the label deleting operation.

When the user wants to add a target label to the instant messaging group “work communication group”, the user may trigger the label adding control 353, to send the label adding operation triggered for the instant messaging group “work communication group” to the client. After receiving the label adding operation triggered by the user, the client may generate a correspondence between the instant messaging group “work communication group” and the target label, that is, the first correspondence.

After the first correspondence is generated, the client may determine whether there is an object associated with the instant messaging group “work communication group”. If the user shares a cloud file A in the “work communication group”, the client may determine that the cloud file A is associated with the instant messaging group “work communication group”. Then, the client may determine whether the user who triggers the label adding operation (for example, the user that is currently logged into the client) has a permission to add a label to the cloud file A. If the user has the permission to add a label to the cloud file A, the client may generate a correspondence between the cloud file A and the target label, to add the label to the cloud document A. In the process of generating the correspondence between the cloud file A and the target label, the client may set the label type of the target label in the correspondence, to the automatic addition type. This type indicates that the target label of the cloud file A is automatically added by the client based on the label adding operation triggered for another object.

It should be noted that, the method described in this embodiment may be combined with the method described in the foregoing embodiments if there is no contradiction. Moreover, solutions obtained by combinations are also covered within the protection scope of the embodiments of the present disclosure.

The method for adding the label to the first object and the second object are described above. After the first correspondence and the second correspondence are generated, the client may further display the first object and the target label in an association manner, and/or, display the second object and the target label in an association manner.

It should be noted that the “user” described in this embodiment and the “user” described in the embodiment shown in FIG. 2 may be the same user or different users. For example, in the scenario of project collaboration, the “user” described in this embodiment may be different from the “user” described in the preceding embodiments. That is, for multiple users collaborating under one project, when one of the users adds a label to an object in the project, the client may automatically add the label to another associated object, and display the label to users among the multiple users other than the user.

Before the target label and the first object and the second object that have the target label are displayed, it may be determined whether a user currently logging into the client belongs to a sharing range. The sharing range includes pre-set users that have a viewing permission for the target label, the first object and the second object. If the user currently logging into the client belongs to the users in the sharing range, the target label and the first object may be presented to the user in the association manner, or the target label and the second object may be presented to the user in the association manner. For example, the client may display the target label in association with the first object, in an interface for displaying the first object. In addition, the client may display the second object in association with the target label, in the interface for displaying the target label.

In an embodiment of the present disclosure, the client may display the target label in the interface for displaying the first object or the second object, or may jump to the label display interface of the target label based on an operation of the user, which will be described in detail below.

In a first possible implementation, the client may display the target label in an interface for displaying the first object or the second object. The client may display the target label in the interface for displaying the first object or the second object. For example, assuming that the first object is an instant messaging group, the client may display the target label of the instant messaging group on an interface for displaying the title of the instant messaging group (such as the title display interface 210 in FIG. 2). Certainly, in some other implementations, the client may display a label viewing control on the interface for displaying the first object or the second object. After a label viewing operation triggered by the user on the label viewing control is received, the target label is displayed.

In a second possible implementation, the client may jump to the label display interface of the target label based on the operation of the user, and display the first object and the second object in the label display interface, which is described in detail below.

In an embodiment of the present disclosure, the client may display a label browsing interface according to a jumping operation triggered by the user, and display at least one label that is viewable by the user (for example, the label that the user has a permission to view) in the label browsing interface. By operating on any label in the label browsing interface, the user may control the client to jump to the label display page corresponding to the label. In the label display interface, the client may display at least one object with the label.

That is, when the user wants to view the object with the target label, the user may first trigger the jumping operation to control the client to display the label browsing interface. Then, the user may operate on the target label displayed in the label browsing interface, to control the client to further display the label display interface of the target label. In this way, the objects with the target label may be viewed in the label display interface of the target label.

In an embodiment of the present disclosure, the label viewing control may be located in an initial interface of the client, or in any other interfaces. Correspondingly, the user may trigger the label viewing operation in the initial interface or any other interfaces of the client.

The above process will be described below by taking the jumping operation triggered by the user on the interface of the instant messaging group as an example.

As shown in FIG. 4, when the client displays the interface of the group chat instant messaging message, the display area may include a title display area 410, a message display area 420 and a control display area 430. The title display area 410 is configured to display basic information of the client. For example, in FIG. 4, the title display area 410 displays that the name of the application currently running on the client is “application X”. The message display area 420 is configured to display group chat instant messaging messages. The details of the message display area 420 may refer to the above, and no repeated description is made here.

The control display area 430 is configured to display at least one operation control. In the embodiment shown in FIG. 4, the control display area 430 includes a message viewing control 431, an address book viewing control 432 and a jump control 433. The message viewing control 431 is configured to, when triggered, cause the client to display group chat instant messaging messages. In the embodiment shown in FIG. 4, the message viewing control 431 is in a triggered state. The address book viewing control 432 is configured to, when triggered, cause the client to display the address book. In the embodiment shown in FIG. 4, the address book viewing control 432 is not triggered. The jump control 433 is configured to, when triggered, cause the client to display at least one label. In the embodiment shown in FIG. 4, the jump 433 is not triggered.

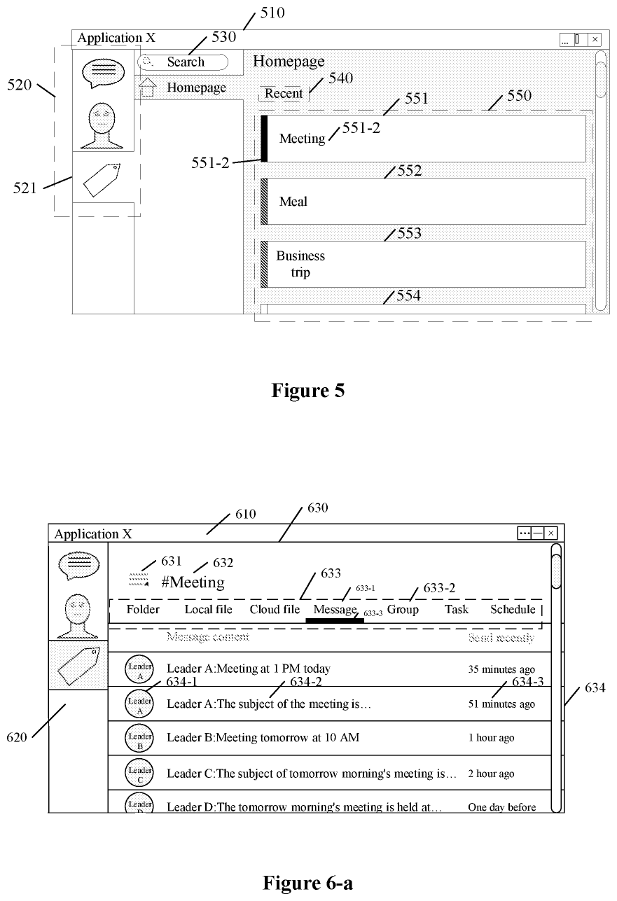

After the user triggers the jump control 433, the client may receive the jumping operation triggered by the user, to jump to a label browsing interface. In an embodiment, the label browsing interface may be as shown in FIG. 5.

When the client displays the label browsing interface, the display area may include a title display area 510, a control display area 520, a search control 530, a sorting information display area 540 and a label display area 550.

The title display area 510 is configured to display basic information of the client. The control display area 520 includes a jump control 521. In the embodiment shown in FIG. 5, the jump control 521 is in a triggered state. The search control 530 is configured to receive a keyword inputted by the user, and search for a label matching the keywords. The sorting information display area 540 is configured to display a sorting rule of label cards in the label display area 550. In the embodiment shown in FIG. 5, the content displayed in the sorting information display area 540 is “recent”, indicating that the sorting rule of the labels in the label display area 550 is that labels are sorted based on the label access times, and the most recently accessed label is ranked first.

The label display area 550 may be configured to display one or more label cards, and each label card may display related information of a label. In the embodiment shown in FIG. 5, the label display area 550 includes a first label card 551, a second label card 552, a third label card 553 and an incompletely displayed fourth label card 854. The first label card 551 includes a color identification area 551-1 and a label name display area 551-2. The color displayed in the color identification area 551-1 is used to indicate a creator of the first label 551, and the label name display area 551-2 is used to display a name of the first label 551. In the embodiment shown in Figure, the color corresponding to the first label card 551 is black, indicating that the label “meeting” currently displayed on the first label card 551 is created by the user currently logging into the client. In other examples, the color displayed in the color identification area 551-1 may also be used to represent other content, which is not limited in the embodiments of the present disclosure.

It should be noted that, the method described in this embodiment may be combined with the method described in the foregoing embodiments if there is no contradiction. Moreover, solutions obtained by combinations are also covered within the protection scope of the embodiments of the present disclosure.

In the label display interface, the user may trigger an operation on any label, to control the client to display at least one object with the label. In an embodiment, the client may display at least one object with the same label in a list.

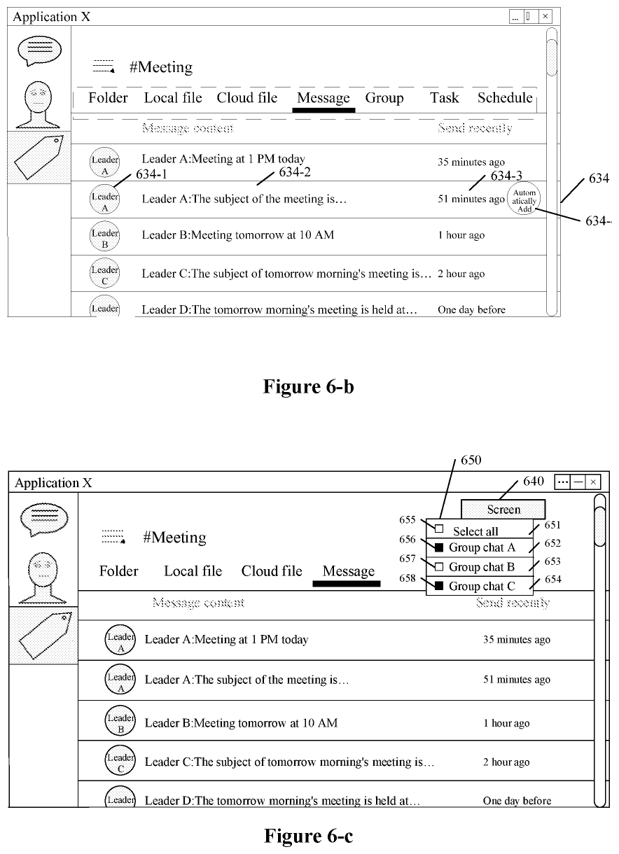

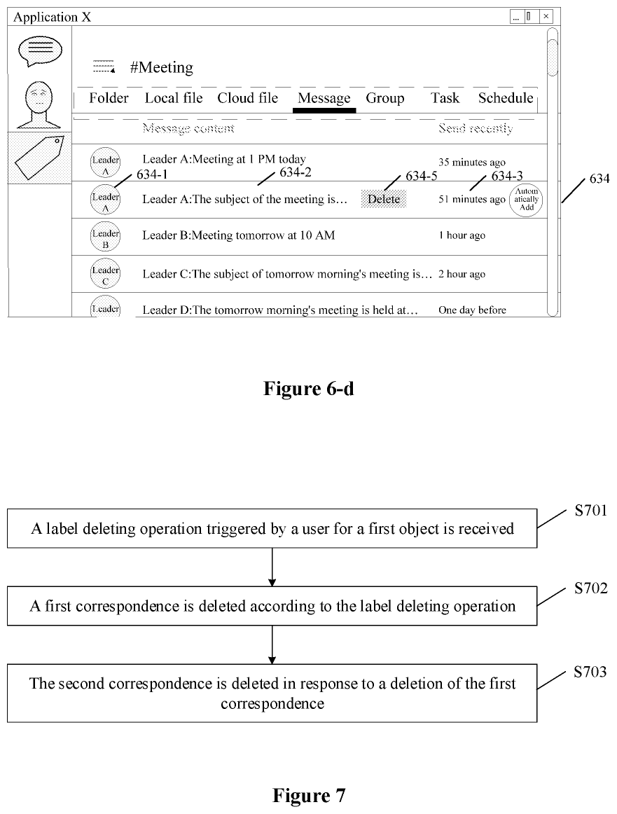

As shown in FIG. 6-a, when the client displays at least one object with the target label in the form of a list, the display area may include a title display area 610, a control display area 620, and a label display area 630. The introduction about the title display area 610 and the control display area 620 may refer to the above embodiments, and no repeated description is made here.

The label display area 630 includes a label switching control 631, a label name display area 632, a label field display area 633 and at least one object information display area.

The label switching control 631 is used to switch to another label. When the user wants to view another label, the user may trigger the label switching control 631. The label name display area 632 is configured to display the name of the label. For example, in the embodiment shown in FIG. 6-a, the user may determine, according to the label name display area 632, that the currently displayed object belongs to the label “meeting”.

The label field display area 633 may reflect a label field that the currently displayed object is from, and may further be used to switch to display an object from another label field. As shown in FIG. 6-a, the label field display area 633 includes a first label field name 633-1, a second label field name 633-2 and annotation information 633-3. The first label field name 633-1 is “message”, which indicates that an object from this label field is an instant messaging message. The second label field name 633-2 is “group”, which indicates that an object from this label field is an instant messaging group. The annotation information 633-3 is used to annotate the label field to which the object currently displayed by the client belongs. In the embodiment shown in FIG. 6-a, the annotation information 633-3 is related to the first label field name 633-1, indicating that the object currently displayed by the client comes from the label field of “instant messaging message”.

In some possible implementations, objects may not be classified according to the label field. Correspondingly, the label display area 630 may not include the label field display area 633.

In an embodiment of the present disclosure, the label display area 630 may include one or more object display areas, and one object display area may be used to display one object with the target label. The following description will be made by taking the label display area 630 including the object display area 634 as an example.

As shown in FIG. 6-a, when the object displayed by the client belongs to the label field of “instant messaging message”, the object display area 634 may include an avatar display area 634-1, a content display area 634-2 and an object information display area 634-3. The avatar display area 634-1 is used to display an avatar of a user who sends the instant messaging message. The content display area 634-2 may display content of the instant messaging message. In an embodiment, when the content of the instant messaging message is large, the content display area 634-2 may display part of the instant messaging message, such as the first ten characters of the message. The object information display area 634-3 is configured to display other information of the instant messaging message. For example, in the embodiment shown in FIG. 6-a, the object information display area 634-3 displays sending time of the instant messaging message. Of course, the object information display area 634-3 may also display other information, for example, the instant messaging group to which the instant messaging message belongs. In an embodiment, when the object displayed in the object display area belongs to the label field such as “cloud file”, the information block of the object, for example, the summary information of the object, may be displayed in the object display area.

In an embodiment, the label display area 630 may further include indication information, for prompting the user of content displayed in each display area of the object display area. For example, in the embodiment shown in FIG. 6-a, the label display area 630 includes two indications of “message content” and “recently sent”. The prompt information of “message content” is used to prompt the user that the corresponding position in the object display area below is used to display content of the instant messaging message. The prompt message “Recently Sent” is used to prompt the user that objects displayed in respective object display area below are arranged in the order of the sending time of the instant messaging messages.

In the label display interface, the user may view at least one object with the target label. The at least one object includes an object, a label of which is added according to the label adding operation for the object: and an object, a label of which is automatically added according to the label adding operation for another object. That is, the object displayed in the label display interface includes both the first object and the second object associated with the first object. In order to distinguish the first object from the second object, the label display interface may include a label type display area, which is used to reflect an adding manner of the label of the object.

As shown in FIG. 6-b, the object display area 634 may include a label type display area 634-4, indicating that the label of the instant messaging message displayed in the object display area 634 is automatically added. That is, the label type of the label “meeting” of the object is the automatic addition type.

It should be noted that, the method described in this embodiment may be combined with the method described in the foregoing embodiments if there is no contradiction. Moreover, solutions obtained by combinations are also covered within the protection scope of the embodiments of the present disclosure.

In some possible implementations, multiple objects having the same target label may include at least two first objects, and second objects respectively associated with the at least two first objects. That is, labels of the at least two second objects may be added based on different label adding operations. For example, the objects with the target label may include a first object A and a first object B, and a second object C associated with the first object A and a second object D associated with the first object B.

Then, in order to distinguish the second objects associated with different first objects, the client may display a screening control in the label display interface. The screening control is configured to screen out second objects associated with one or more first objects. When the user wants to view second objects associated with a target first object, the user may trigger a screening operation through the screening control in the label display interface. After the screening operation is received, the target first object may be determined according to the screening operation, and the second object associated with the target first object may be displayed.

As shown in FIG. 6-c, the label display interface may include a screening control 640. When it is detected that the user triggers the screening control 640, a candidate interface 650 may be displayed to the user. The candidate interface 650 may include a first screening control 651, a second screening control 652, a third screening control 653 and a fourth screening control. The first screening control 651 is configured to control to display second objects associated with all first objects. The second screening control 652 is configured to control to display a second object associated with a first object “group A”. The third screening control 653 is configured to control to display a second object associated with a first object “group B”. The fourth screening control 654 is configured to control the client to display a second object associated with a first object “group C”.

In an embodiment, the candidate interface 650 further includes a first status display area 655, a second status display area 656, a third status display area 657 and a fourth status display area 658. The first status display area 655 is configured to display a triggering status of the first screening control 651, the second status display area 656 is configured to display a triggering status of the second screening control 652, the third status display area 657 is configured to display a triggering status of the first screening control 653, and the fourth status display area 658 is configured to display a triggering status of the fourth screening control 654. In the embodiment shown in FIG. 6-c, the first screening control 651 and the third screening control 653 are in an untriggered state, and the second screening control 652 and the fourth screening control 654 are in a triggered state. It is indicated that objects displayed in the object display area 634 include the second objects associated with the first object “Group A” and the first object “Group C”, and do not include the second object associated with the first object “Group B”.

It should be noted that, the method described in this embodiment may be combined with the method described in the foregoing embodiments if there is no contradiction. Moreover, solutions obtained by combinations are also covered within the protection scope of the embodiments of the present disclosure.

The information interaction method according to the embodiments of the present disclosure is introduced above. By executing the information interaction method according to the embodiment of the present disclosure, a target label may be added to a first object and at least one second object associated with the first object, according to a label adding operation triggered by a user for the first object. In addition, a corresponding label deleting method for deleting the target label of the second object is further provided according to an embodiment of the present disclosure, which is described in detail below:

Referring to FIG. 7, which is a flow chart of a label deleting method according to an embodiment of the present disclosure. The method may be executed by a client or a server. The client (or server) may be the same as or different from the client (or server) in the embodiment shown in FIG. 1. A user described in this embodiment may be the same as or different from the user described above. The label deleting method according to the embodiment of the present disclosure may include the following steps S701 to S703.

For example, in the context of project collaboration, the “user” described in this embodiment may be different from the “user” described in the foregoing embodiments. That is, for multiple users collaborating on one project, the user may delete a label added by another user to the object, and the client may automatically delete the same label of another object associated with the object based on the deletion of the label of the object.

In step S701, a label deleting operation triggered by a user for a first object is received.

In an embodiment of the present disclosure, the client or the server may receive a label deleting operation triggered by the user for the first object, and delete a target label of a first object and a second object according to the label deleting operation. Similar to the information interaction method shown in FIG. 1, the first object may be any one of objects such as a folder, a cloud file, a local file, a schedule, a task, an instant messaging message, and an instant messaging group. The second object may be any one of objects associated with the first object, such as a folder, a cloud file, a local file, a schedule, a task, an instant messaging message, and an instant messaging group.

In an embodiment, the label deleting operation may be triggered for the target label of the first object, or may be triggered by a deleting operation triggered by a user for the first object. The two implementations are introduced respectively below:

The first implementation is introduced first. In the first implementation, the label deleting operation is triggered by the user for the target label of the first object. That is, the user triggers the label deleting operation to delete the target label of the first object, not to delete the first object or the second object. In an embodiment, the label deleting operation may be triggered by the user on a label deleting control. The label deleting control is configured to delete the target label of the first object.

If the label deleting operation is triggered by the user for the target label of the first object, the user may trigger the label deleting operation in an interface for displaying the first object, or trigger the label deleting operation in an interface for displaying the target label. The two cases are respectively introduced below:

In the first case, the user triggers the label deleting operation through the label deleting control in the interface for displaying the first object. For example, the client may display the label deleting control in the interface for displaying the first object, and the user may trigger the label deleting operation by clicking the label deleting control displayed on the client.

For example, assuming that the first object is an instant messaging group, the client may display the label deleting control on in an interface for displaying the instant messaging group. For example, the label deleting control may be displayed in the interface shown in FIG. 2 or FIG. 3. The user may trigger the label deleting operation by clicking the label deleting control displayed on the client. In an embodiment of the present disclosure, the label deleting control may be used to delete the target label of the first object, or may be used to delete all labels of the first object.

In addition, in some other implementations, the client may display the label deleting control based on a display operation triggered by the user, so that the user triggers the label deleting operation through the label deletion control. That is, the client may first hide the label deleting control, and display the label adding control based on the display operation triggered by the user, so that the user may trigger the label deleting operation through the label deleting control.

For example, assuming that the first object is a folder, the client may not display the label deleting control in an interface for displaying the folder. Based on a right-click operation (equivalent to the aforementioned display operation) of the user, an operation control list including the label deleting control is displayed.

In the second case, the user triggers the label deleting operation in the interface for displaying the target label. For example, the client may display a label deleting control in the label display interface as shown in FIG. 6-b or FIG. 6-c, so that the user may trigger the label deleting operation through the label deleting control.

As shown in FIG. 6-d, when the client displays the label deleting control in the label display interface, the object display area 634 may include a label deleting control 634-5. The user may trigger the label deleting operation through the label deleting control 634-5. The label deleting operation is used to delete the label “meeting” of the instant messaging message “the topic discussed at the meeting is . . . ”.

The second implementation is introduced below: In the second implementation, the user wants to delete the first object and triggers the deleting operation for the first object. The first object may be deleted based on the deleting operation triggered by the user. Based on this, the correspondence between the first object and the target label may also be deleted, that is, the label deleting operation is triggered by the deleting operation triggered by the user for the first object.

In an embodiment, the user may trigger the deleting operation for the first object. After the deleting operation triggered by the user is received, it is determined whether the first object has a label based on the deleting operation. If the first object has a label, the label deleting operation may be obtained according to the deleting operation triggered by the user. Then, the label of the first object is deleted according to the label deleting operation.

It should be noted that when the label deleting operation is triggered by the deleting operation for the first object, the label deleting operation may be used to delete the target label of the first object, and may further be used to delete a label of the first object other than the target label.

In step S702, a first correspondence is deleted according to the label deleting operation.

After the label deleting operation is received, the first correspondence may be deleted according to the label deleting operation. The first correspondence is a correspondence between the first object and the target label. In an embodiment, before the first correspondence is deleted, the first object and the target label may be determined according to the label deleting operation, so as to determine the first correspondence.

In step S703, the second correspondence is deleted in response to a deletion of the first correspondence.

After it is determined that the first correspondence is deleted, the second correspondence may be deleted. The second correspondence is a correspondence between the second object and the target label, and the second object is associated with the aforementioned second object. The introduction of the first object, the second object, the first correspondence and the second correspondence may refer to the description of the embodiment shown in FIG. 2, and no repeated description is made here.

Thus, in the label deleting method according to the embodiments of the present disclosure, the label of the first object may be deleted based on the label deleting operation for the first object, and the label of the second object may be automatically deleted based on “the label of the first object being deleted”. In this way, when the user wants to delete labels of multiple objects in batches, the user only needs to trigger the label deleting operation on each of the first objects, rather than triggering the label deleting operation on each object separately.

In an embodiment of the present disclosure, the deletion of the second correspondence is automatically performed based on the deletion of the first correspondence. Therefore, before deleting the second correspondence, the second correspondence to be deleted may be determined first. In an embodiment, the first correspondence may be determined according to the label deleting operation first, and then the second correspondence may be determined according to the first correspondence, so as to delete the second correspondence.

Since the first correspondence is the correspondence between the target label and the first object, when determining the second correspondence according to the first correspondence, the client or the server may determine the second correspondence in two different manners, which are introduced separately below.

In the first possible manner, the second object may be determined according to the first object, the target label may be determined according to the first correspondence, and the second correspondence may be determined and deleted according to the second object and the target label. In an embodiment, an association relationship between the second object and the first object may be recorded when the second object is received. When it is detected that the user triggers the label deleting operation for the first object, the second object associated with the first object may be determined according to the recorded association relationship. In addition, the target label to be deleted may also be determined according to the first correspondence. After the target label and the second object are determined, the correspondence between the target label and the second object, that is, the second correspondence may be deleted.

In the second possible manner, the target label to be deleted may be determined first, and the second object associated with the first object is screened out from objects with the target label. Then, the second correspondence is determined and deleted according to the second object and the target label. In an embodiment, the target label may be firstly determined according to the first correspondence, and at least one object corresponding to the target label may be obtained. Next, it may be determined whether the at least one object is associated with the first object. If an object with the target label is associated with the first object, the object may be determined as the second object, thereby deleting the target label of the second object.

Before deleting the second correspondence, the client or the server may determine whether the second correspondence is automatically generated, that is, whether the second correspondence is generated based on the label adding operation triggered for the first object. If the second correspondence is automatically generated, the second correspondence may be automatically deleted based on the deletion of the first correspondence. If the second correspondence is not automatically generated, it means that the user independently triggers the label adding operation for the second object, and the second correspondence may be retained.

In an embodiment, it may be determined whether the label type of the target label in the second correspondence is the automatic addition type. If the label type of the target label in the second correspondence is the automatic addition type, it means that the second correspondence is automatically generated based on the label adding operation triggered for the first object, the second correspondence may be automatically deleted based on the label deleting operation triggered for the first object. The client or the server may delete the second correspondence according to the aforementioned label deleting operation. On the contrary, if the label type of the target label in the second correspondence is not the automatic addition type, the client or the server may not delete the second correspondence. For example, if the label type of the target label in the second correspondence is a manual addition type, it means that the second correspondence is generated based on a label adding operation triggered by the user for the second object, and the second correspondence may be retained.

In an actual application scenario, the second object may be associated with multiple objects. Then, if the user deletes the target label of any one of the objects and does not delete the target labels of other objects, the correspondence between the second object and the target label may be retained. If the target labels of all objects associated with the second object are all deleted, the second correspondence may be deleted.

For example, it is assumed that the first object is associated with the second object, a third object is also associated with the second object, the first object, the second object and the third object all have the target label, and a correspondence between the third object and the target label is a third correspondence.

After receiving the label deleting operation triggered by the user for the first object, the client or the server may delete the first correspondence according to the label deleting operation, and determine the second object and the second correspondence according to the first correspondence. Next, it may be determined whether the second object is associated with other objects. Since the second object is also associated with the third object, the second correspondence may be retained, and the target label of the second object is not deleted.

After receiving the label deleting operation triggered by the user for the third object, it may be further determined whether the second object is associated with other objects in a target object set except the first object and the second object. The target object set includes at least one object with the target label (for example, the first object and the third object). If the second object is associated with any object in the target object set other than the first object and the second object, the second correspondence may be retained. If the second object is not associated with any object in the target object set other than the first object and the second object, the second correspondence may be deleted. Before the second correspondence is deleted, the second object may be displayed in the label display interface of the target label.

It should be noted that, the method described in this embodiment may be combined with the method described in the foregoing embodiments if there is no contradiction. Moreover, solutions obtained by combinations are also covered within the protection scope of the embodiments of the present disclosure.

In an actual application scenario, a user may send a wrong message or file in the instant messaging application, which may easily cause trouble to other users in the instant messaging group. In order to solve this problem, the instant messaging application may have a withdrawing function. The user may trigger a withdrawing operation for the sent instant messaging message or file, to delete the mistakenly sent instant messaging message or file.

According to the foregoing introduction, with the information interaction method according to the embodiments of the present disclosure, the target label may be automatically added to the second object associated with the first object. Then, when the first object is an instant messaging group, if the user sends a wrong instant messaging message or file in the instant messaging group, the client or server may automatically add the target label to the instant messaging message or file. However, since the instant messaging message or file is mistakenly sent to the instant messaging group, the user may not actually want to add the target label to the instant messaging message or file.

In order to solve this problem, in the method according to the embodiments of the present disclosure, the client or the server may delete the automatically generated second correspondence according to a withdrawing operation triggered by the user.

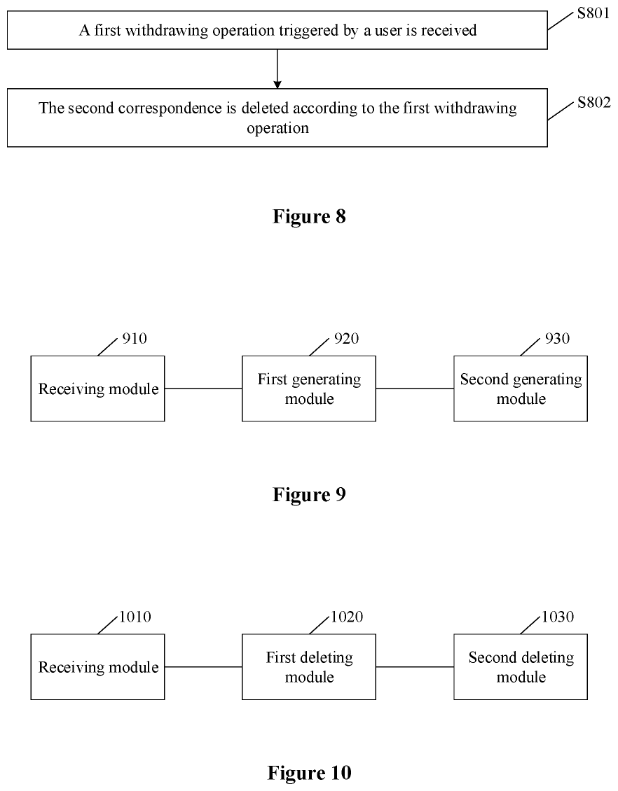

FIG. 8 is a flow chart of a label deleting method according to another embodiment of the present disclosure. Referring to FIG. 8, the method includes the following steps S801 to S802.

In step S801, a first withdrawing operation triggered by a user is received.

Before deleting the second correspondence, the client or the server may receive a first withdrawing operation triggered by the user, where the first withdrawing operation is used to release the association relationship between the first object and the second object. In a case that the first object is an instant messaging group, releasing the association relationship between the first object and the second object is equivalent to withdrawing the second object from the instant messaging group.

In an embodiment of the present disclosure, the user may trigger the first withdrawing operation through a withdrawing control. For example, when the first object is an instant messaging group, the client may display the withdrawing control corresponding to the second object based on an operation of the user. For example, the client may display the withdrawing control corresponding to the second object based on a right click or a long press operation of the user. Of course, the client may also directly display the withdrawing control corresponding to the second object in the interface for displaying the second object, so that the user may trigger the first withdrawing operation through the withdrawing control.

In step S802, the second correspondence is deleted according to the first withdrawing operation.

After receiving the first withdrawing operation, the client or server may delete the association relationship between the first object and the second object according to the first withdrawing operation, and delete the second correspondence based on the release of the association relationship between the first object and the second object. In this way, if a wrong second object is sent, the user may withdraw the second object by triggering the first withdrawing operation. After the second object is withdrawn by the user, the target label of the second object may also be deleted based on “the second object being withdrawn from the first object”. In this way, the target label of the second object is automatically deleted according to the first withdrawing operation of the user, and the user does not need to trigger the label deleting operation to delete the target label of the second object after the second object is withdrawn.

Similar to step S702, when step S802 is executed, it may be determined whether the second object is associated with other objects with the target label. If the second object is not associated with any other objects with the target label, the second correspondence may be automatically deleted according to the first withdrawing operation. If the second object is associated with any object having the target label, the second correspondence may not be automatically deleted.

Assuming that the second object is associated with the third object, the client or the server may delete the association relationship between the first object and the second object according to the first withdrawing operation. If the association relationship between the second object and the third object is also released, the second correspondence may be automatically deleted based on the release of the association relationship between the second object and the third object. Similarly, if the label deleting operation triggered for the third object is received, the second correspondence may be automatically deleted. If neither the second withdrawing operation nor the label deleting operation triggered for the third object is received, the target label of the second object may be retained. In an embodiment, the second object may be displayed in the label display interface of the target label.

For example, it is assumed that an instant messaging group A and an instant messaging group B have a label X, and the user sends a cloud file Y in both the instant messaging group A and the instant messaging group B. If the user wants to withdraw the cloud file Y in the instant messaging group A, the first withdrawing operation may be triggered, and the first withdrawing operation is used to release the association relationship between the instant messaging group A and the cloud file Y. After the first withdrawing operation is received, since the cloud file Y is also associated with the instant messaging group B, the correspondence between the cloud file Y and the label X may be retained, and the association relationship between the cloud file Y and the instant messaging group A may be released.

If the user triggers a second withdrawing operation for withdrawing the cloud file Y in the instant messaging group B or triggers the label deleting operation for the instant messaging group B, in the case that the cloud file Y is not associated with any object in the target object set except the first object and the third object, the second correspondence may be deleted.

It should be noted that, the method described in this embodiment may be combined with the method described in the foregoing embodiments if there is no contradiction. Moreover, solutions obtained by combinations are also covered within the protection scope of the embodiments of the present disclosure.

FIG. 9 is a schematic structural diagram of an information interaction apparatus according to an embodiment of the present disclosure. This embodiment is applicable to a situation where a target label is added to a first object in a client, and the target label is automatically added to a second object. The apparatus may include a receiving module 910, a first generating module 920 and a second generating module 930.

The receiving module 910 is configured to receive a label adding operation triggered by a user for a first object.

The first generating module 920 is configured to generate a first correspondence between a target label and the first object, according to the label adding operation.

The second generating module 930 is configured to generate a second correspondence between the target label and a second object in response to a generation of the first correspondence, where the second object is associated with the first object.

The information interaction apparatus according to the embodiment of the present disclosure may execute the information interaction method according to any embodiment of the present disclosure, and has corresponding functional modules and beneficial effects for performing the information interaction method. It should be noted that the units and modules included in the above embodiment of the information interaction apparatus are only divided according to functional logic, but are not limited to the above division, as long as the corresponding functions can be realized. In addition, the names of respective functional units are only for the convenience of distinguishing the functional units from each other, and are not used to limit the protection scope of the present disclosure.

FIG. 10 is a schematic structural diagram of an information interaction apparatus according to an embodiment of the present disclosure. This embodiment can be applied to the situation where a client deletes a target label of a first object and automatically deletes the target label of a second object. The apparatus may include a receiving module 1010, a first deleting module 1020 and a second deleting module 1030.

The receiving module 1010 is configured to receive a label deleting operation triggered by a user for a first object.

The first deleting module 1020 is configured to delete a first correspondence between a target label and the first object, according to the label deleting operation.

The second deleting module 1030 is configured to delete a second correspondence between the target label and a second object in response to a deletion of the first correspondence, where the second object is associated with the first object.

The information interaction apparatus according to the embodiment of the present disclosure may execute the information interaction method according to any embodiment of the present disclosure, and has corresponding functional modules and beneficial effects for performing the information interaction method. It should be noted that the units and modules included in the above embodiment of the information interaction apparatus are only divided according to functional logic, but are not limited to the above division, as long as the corresponding functions can be realized. In addition, the names of respective functional units are only for the convenience of distinguishing the functional units from each other, and are not used to limit the protection scope of the present disclosure.

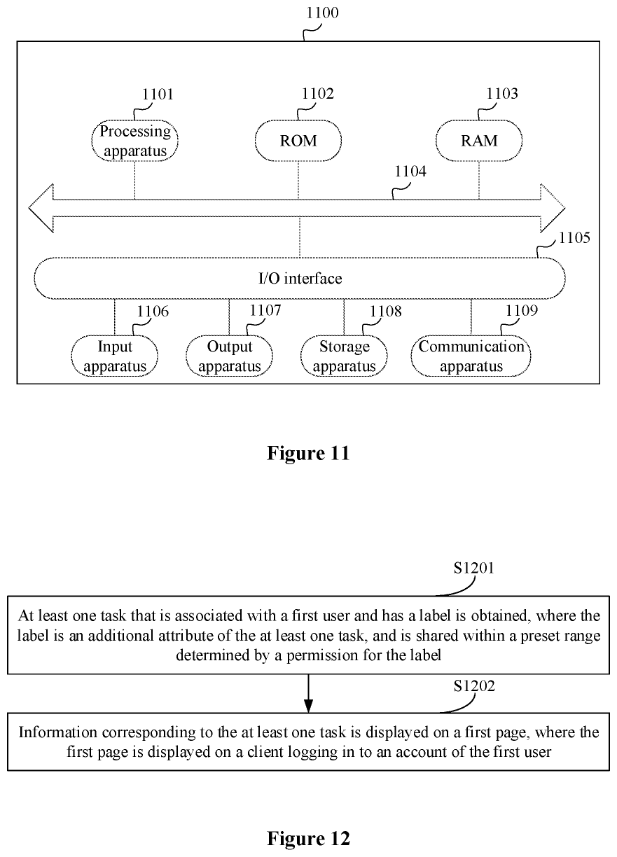

Reference is made to FIG. 11, which is a schematic structural diagram of an electronic device 1100 (for example, a terminal device or a server on which a client is running) suitable for implementing the embodiments of the present disclosure. The terminal device in the embodiments of the present disclosure may include, but is not limited to, a mobile terminal such as a mobile phone, a notebook computer, a digital broadcast receiver, a PDA (a personal digital assistant), a PAD (a tablet), a PMP (a portable multimedia player), a vehicle-mounted terminal (for example, an in-vehicle navigation terminal), and the like, and a stationary terminal such as a digital TV, a desktop computer, and the like. The electronic device shown in FIG. 11 is only an example, and should not impose any limitation on the function and scope of use of the embodiments of the present disclosure.

As shown in FIG. 11, the electronic device 1100 may include a processing apparatus 1101 such as a central processing unit or a graphics processor, which can execute various appropriate actions and processes based on a program stored in a Read Only Memory (ROM) 1102 or a program loaded from a storage apparatus 1108 into a Random Access Memory (RAM) 1103. In the RAM 1103, various programs and data required by the electronic device 1100 for operation are further stored. The processing apparatus 1101, the ROM 1102, and the RAM 1103 are connected to each other through a bus 1104. An input/output (I/O) interface 1105 is also connected to the bus 1104.

Generally, the following may be connected to the I/O interface 1105: an input apparatus 1106 such as a touch screen, a touch pad, a keyboard, a mouse, a camera, a microphone, an accelerometer, a gyroscope, an output apparatus 1107 such as a Liquid Crystal Display (LCD), a speaker, a vibrator, a storage apparatus 1108 such as a magnetic tape, a hard disk, and a communication apparatus 1109. Based on the communication apparatus 1109, the electronic device may communicate with other devices through wired or wireless communication to exchange data. Although FIG. 11 shows the electronic device including various apparatuses, it should be understood that not all shown apparatuses are required to be implemented or included. The shown apparatuses may be replaced by other apparatuses, or more or less apparatuses may be included.

Specifically, the processes described with reference to flow charts, may be implemented as a computer software program according to an embodiment of the present disclosure. For example, a computer program product is provided according to an embodiment of the present disclosure, the computer program product includes a computer program embodied on a non-transitory computer readable medium. The computer program includes program codes for performing the method shown in the flowchart. In such embodiments, the computer program may be downloaded and installed from the network through the communication apparatus 1109, installed from the storage apparatus 1108, or installed from the ROM 1102. The computer program, when being executed by the processing apparatus 1101, performs functions defined in the method according to the embodiments of the present disclosure.

The electronic device according to the embodiments of the present disclosure belongs to the same inventive concept as the information interaction method and the label deletion method according to the above embodiments of the present disclosure. For technical details not described in detail in the embodiments of the present disclosure, reference can be made to the above embodiments, and the embodiments of the present disclosure have the same beneficial effect as the above embodiments.

A computer storage medium, on which a computer program is stored, is provided according to an embodiment of the present disclosure. When the program is executed by a processor, the information interaction method or the label deleting method according to the foregoing embodiments is implemented.

It should be noted that the computer readable medium according to the present disclosure may be a computer readable signal medium or a computer readable storage medium or any combination of the two. The computer readable storage medium may include, for example, but not limited to, an electronic, magnetic, optical, electromagnetic, infrared, or semiconductor system, apparatus, or device, or any combination of the foregoing. More particularly, the computer readable storage medium may include, but not limited to, an electrical connection having one or more wires, a portable computer diskette, a hard disk, a Random Access Memory (RAM), a Read Only Memory (ROM), an Erasable Programmable Read Only Memory (EPROM or a flash memory), an optical fiber, a portable Compact Disk Read-Only Memory (CD-ROM), an optical storage device, a magnetic storage device, or any suitable combination of the foregoing. In the present disclosure, the computer readable storage medium may be any tangible medium containing or storing a program, where the program may be used by an instruction execution system, apparatus or device or used in combination therewith. In the present disclosure, the computer readable signal medium may include a data signal transmitted in a baseband or transmitted as a part of a carrier wave. The data signal carries computer readable program codes. The transmitted data signal may have a variety of forms including, but not limited to, an electromagnetic signal, an optical signal, or any suitable combination of the foregoing. The computer readable signal medium may also be any other computer readable medium except for the computer readable storage medium. The computer readable signal medium may send, transmit or transfer programs used by an instruction execution system, apparatus or device or used in combination therewith. The program codes included in the computer readable medium may be transferred through any proper medium including, but not limited to, an electric wire, an optical cable, RF (Radio Frequency), and the like, or any suitable combination of the foregoing.

In some embodiments, the client and the server may communicate with each other by using any currently known or future network protocol such as HTTP (HyperText Transfer Protocol), and may be connected with a digital data network in any form or medium (such as a communication network). Examples of communication networks include a local area network (LAN), a wide area network (WAN), an internet (for example, the Internet), and a peer-to-peer network (such as the ad hoc peer-to-peer network), as well as any current known or future networks.

The above computer-readable medium may be included in the above electronic device, or may exist alone without being assembled into the electronic device.

The above computer-readable medium carries one or more programs. The above one or more programs, when being executed by the electronic device, cause the electronic device to: receive a label adding operation triggered by a user for a first object, generate a first correspondence between a target label and the first object according to the label adding operation, and generate a second correspondence between the target label and a second object in response to a generation of the first correspondence, where the second object is associated with the first object: or cause the electronic device to receive a label deleting operation triggered by a user for a first object, delete a first correspondence between a target label and the first object according to the label deleting operation, and delete a second correspondence between the target label and a second object in response to a deletion of the first correspondence, where the second object is associated with the first object.

The computer program codes for performing the operations according to the present disclosure may be written in at least one programming language or a combination of the at least one programming language. The programming language includes, but is not limited to, an object oriented programming language such as Java, Smalltalk, C++ and a conventional procedural programming language such as “C” programming language or a programming language similar to “C” programming language. The program codes may be completely executed on a user computer, partially executed on the user computer, executed as a standalone software package, partially executed on the user computer and partially executed on a remote computer, completely executed on the remote computer or a server. In the cases relating to the remote computer, the remote computer may be connected to the user computer via any kind of networks including Local Area Network (LAN) or Wide Area Network (WAN), or the remote computer may be connected to an external computer (for example, via Internet provided by an Internet service provider).

The flowchart and block diagrams in the drawings illustrate the architecture, functionality, and operations of possible implementations of systems, methods and computer program products according to various embodiments of the present disclosure. In this regard, each block in the flowcharts or block diagrams may represent a module, program segment, or a portion of code that contains one or more executable instructions for implementing the specified logical functions. It should also be noted that, in some alternative implementations, the functions noted in the blocks may occur in an order other than the order shown in the drawings. For example, two blocks shown in succession may be executed substantially concurrently, or the blocks may sometimes be executed in the reverse order, depending upon the functionality involved. It is also noted that each block of the block diagrams and/or flowchart illustrations, and combinations of blocks in the block diagrams and/or flowchart illustrations, may be implemented in dedicated hardware-based systems that perform the specified functions or operations, or may be implemented by a combination of dedicated hardware and computer instructions.

The modules involved in the embodiments of the present disclosure may be implemented in a software manner, or in a hardware manner. The name of the modules does not constitute a limitation of the modules under any circumstances. For example, the editable content display unit may also be referred to as “editing unit”.

The functions described above may be performed, at least in part, by one or more hardware logic components. For example, without limitation, examples of hardware logic components that may be used include: a Field Programmable Gate Array (FPGA), an Application Specific Integrated Circuit (ASIC), an Application Specific Standard Product (ASSP), a System on Chip (SOC), a Complex Programmable Logical Device (CPLD) and the like.

In the context of the present disclosure, a machine-readable medium may be a tangible medium that may contain or store a program for use by an instruction execution system, apparatus or device, or used in combination therewith. The machine-readable medium may be a machine-readable signal medium or a machine-readable storage medium. Machine-readable media may include, but are not limited to, electronic, magnetic, optical, electromagnetic, infrared, or semiconductor systems, apparatuses, or devices, or any suitable combination of the foregoing. More specific examples of machine-readable storage media include one or more wire-based electrical connections, a portable computer disk, a hard disk, a Random Access Memory (RAM), a Read Only Memory (ROM), an Erasable Programmable Read Only Memory (EPROM or a flash memory), a optical fiber, a Compact Disk Read Only Memory (CD-ROM), an optical storage device, a magnetic storage device, or any suitable combination of the foregoing.

Currently, some applications may provide a task creation function. In an example, a label may be added to a task. In practical applications, if a user participates in multiple projects collaborated by multiple person, the user not only needs to view a task related to a certain project, but also needs to collectively view and manage tasks related to himself. If the user needs to view the tasks related to himself, the user needs to open a label page of each task, so as to view the tasks. The user operation is cumbersome and inefficient.

The inventor of the present disclosure found through research that a certain user may be related to many tasks. If the user needs to view the tasks related to himself, the user needs to open the label page of each task, so as to view the tasks. For example, there are three tasks related to a user A, and these three tasks have a label 1, a label 2 and a label 3 respectively. Then, the user A needs to open a page corresponding to the label 1 to view the task 1, open a page corresponding to the label 2 to view the task 2, and open a page corresponding to the label 3 to view the task 3. The user operation is cumbersome and inefficient.

In order to solve the above problem, a task-based information processing method and a task-based information processing apparatus are provided according to embodiments of the present disclosure.

Reference is made to FIG. 12, which is flowchart of a task-based information processing method according to an embodiment of the present disclosure.

The method according to the embodiment of the present disclosure may be executed by a client. In an embodiment of the present disclosure, a target application may be installed on the client. A first user mentioned in the embodiment of the present disclosure refers to a user who logs into an account of the target application on the client.

The symbol “#” in the drawings of the embodiments of the present disclosure is a label identifier. Of course, the label identifier is not limited to “#”, which may be other symbols.

The following method shown in FIG. 12 and the method shown in FIG. 14 may be combined and referred to each other if there is no contradiction.

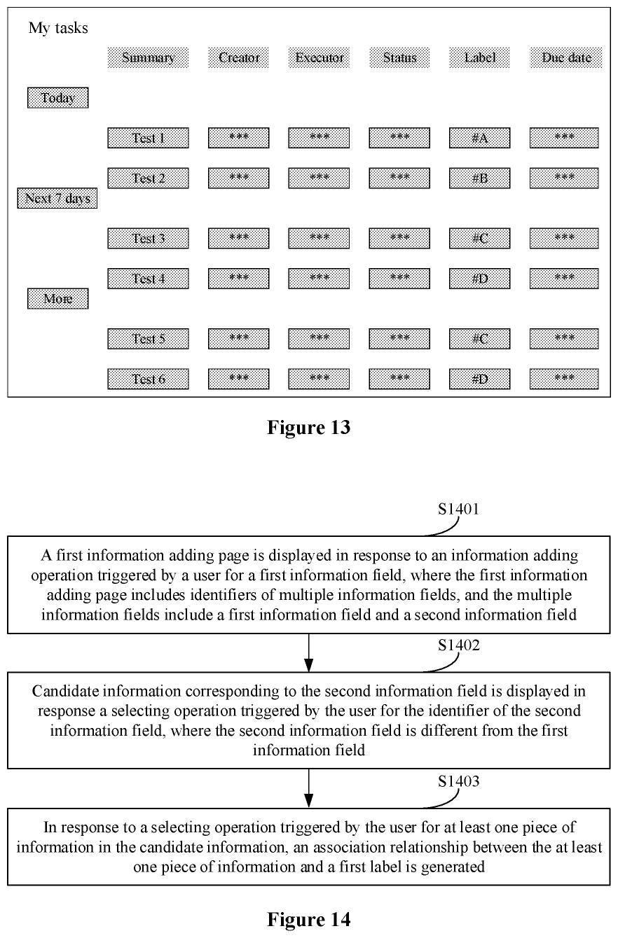

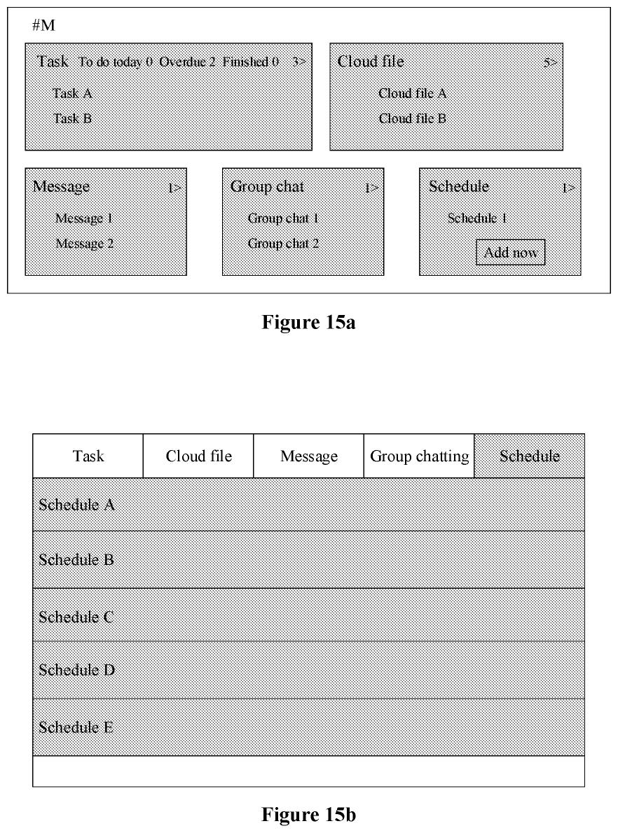

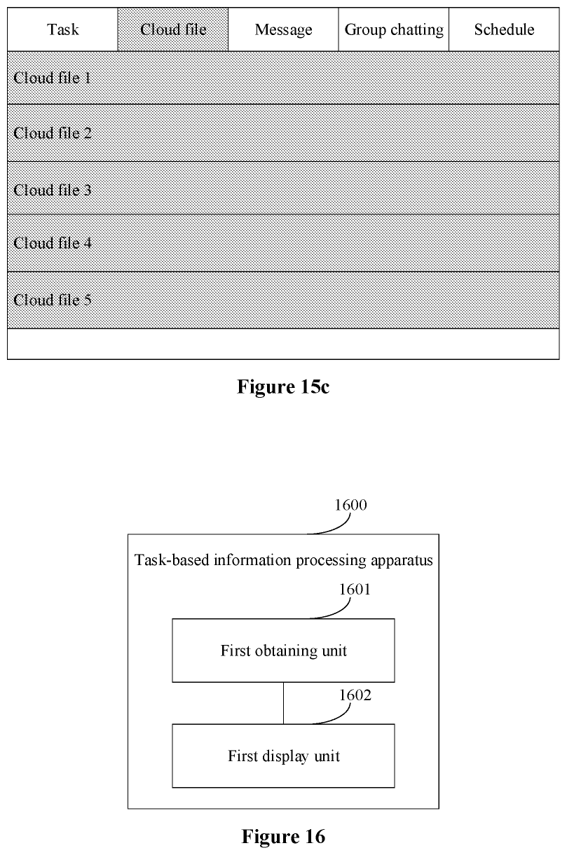

All the drawings in the embodiments of the present disclosure, such as FIG. 13, FIG. 15a, FIG. 15b and FIG. 15c, are shown for the convenience of understanding the content related to the embodiments of the present disclosure, and do not constitute a limitation to the embodiments of the present disclosure. The pages shown in FIG. 13, FIG. 15a, FIG. 15b and FIG. 15c may further include other content, which is not limited in the embodiments of the present disclosure.

In an embodiment, the method shown in FIG. 12 may include the following steps, for example: S1201-S1202.

In step S1201, at least one task that is associated with a first user and has a label is obtained, where the label is an additional attribute of the at least one task, and is shared within a preset range determined by a permission for the label.

In an embodiment of the present disclosure, the task related to the first user may include three cases. The first case is a task created by the first user, that is, a task whose creator is the first user. The second case is a task in which the first user is the executor, such as a task created by a second user and specified to be executed by executors including the first user, or a task created by the first user, and specified to be executed by the first user himself. The third case is a task concerned by the first user. For example, the first user is a supervisor of a project, who concerns the task related to the project, to be informed of the execution progress of the project.

It should be noted that, in the embodiments of the present disclosure, the label is not limited to be used only locally on the client of the first user. The label may be shared within a certain range. In an embodiment, the sharing range of the label may be determined by the permission for the label. Next, a first label is taken as an example to introduce the sharing attribute of the label.

In an example, the permission for the first label may include a usage permission. The usage permission refers to a permission to add the first label to an information unit. A user having the usage permission for the first label is allowed to add the first label to an information unit on a client corresponding to the user. The usage permission for the first label may be set by an owner of the first label, and the owner of the first label may designate a user having the usage permission for the first label.

In an example, the permission for the first label includes a viewing permission. The viewing permission refers to a permission to view associated information of the first label. In an embodiment, the associated information of the first label is displayed on the client of the user having the viewing permission for the first label. In other words, the user having the viewing permission for the first label may view the associated information of the first label on a client corresponding to the user.

In some embodiments, it is considered that the information unit itself also has a viewing permission. Then, for the first user having the viewing permission for first label, the information that is associated with the first label and that is displayed on the client of the first user may be information that the first user has the viewing permission. In other words, the associated information of the first label that is presented on the client of the first user does not include information for which the first user does not have the viewing permission. In this way, information security can be effectively protected, and information leakage caused by the first user viewing information for which he does not have the viewing permission can be avoided. In an example, for a first information unit for which the first user has the viewing permission, if the first information unit has the first label, the client of the first user may display the first information unit and the first label in association with the first information unit. In this way, the first user may determine content of the first information unit, according to the first label and the first information unit that are displayed in an association manner; and determine that the first information unit has the first label.

In step S1202, information corresponding to the at least one task is displayed on a first page, where the first page is displayed on a client logging in to an account of the first user.

After the at least one task is obtained, the client may display information corresponding to the at least one task on the first page displayed on the client. In this way, the first user may view information of at least one task related to the user on the first page, without opening pages corresponding to respective labels, which simplifies the user operation and improves the efficiency of the user viewing tasks related to the user.

Regarding the information of the at least one task, a first task among the at least one task is taken as an example. The information of the first task refers to information related to the first task. Information of the first task includes, but is not limited to, any one or more of the following: a label of the first task, a creator of the first task, an executor of the first task, a due date of the first task, a status of the first task, and summary information of the first task.

The status of the first task may include: a finished status or an unfinished status. The summary information of the first task may be, for example, a subject of the first task, or a key word in a task description of the first task.

In some embodiments, the information corresponding to respective tasks may be displayed on the first page in a form of a list. When displayed on the first page in the form of a list, the information of one task may correspond to one record in the list, where content included in the information of each task is indicated by a header of the list.

For example, the header of the list includes: a label, a creator, an executor, a due date, a status, and summary information. The information of each task includes: a label of this task, a creator of this task, an executor of this task, a due date of this task, a status of this task, and summary information of this task. As an example, the executor of each task may be a user name of the executor of this task, or an account avatar of the executor of this task, which is not limited in the embodiments of the present disclosure. Correspondingly, the creator of each task may be a username of the creator of this task, or an account avatar of the creator of this task, which is not limited in the embodiments of the present disclosure.

It should be noted that content included in the header of the list may be customized by the first user. In other words, the first user may select the content that is included in the information of the at least one task and is displayed on the first page.

In an example, the first user may trigger a task information selecting operation for the header. After the first user triggers the task information selecting operation, the client may determine the content included in the information of each task and displayed on the first page, in response to the task information selecting operation. In some embodiments, the header may include by default: a label, a creator, an executor, a due date, a status, and summary information. The first user may trigger a cancelling operation on one or more of the label, the creator, the executor, the due date, the status and the summary information, to delete part of the information from the header. For example, if the first user clicks the “Creator” in the header and further triggers a control to delete the “Creator”, then the header of the list will no longer include “Creator”. Correspondingly, the creator of the at least one task is not displayed on the first page.

In some embodiments, it is considered that the task has a due date. The due date closer to the current date indicates less time remaining to complete the task. In an example, when the information of the at least one task is displayed on the first page, the information of the at least one task may be sorted in a certain order. In an embodiment, the information of the at least one task may be sorted based on the due date of the at least one task in a reverse order. In this way, according to the content displayed on the first page, the first user may intuitively determine a task with a most recent due date, to make reasonable arrangements for the work progress and not to miss the due date of the task.

In some embodiments, for tasks related to the first user, although some tasks have due dates that has a long time from the current date, these tasks may be most concerned by the first user, or these tasks have a high urgency degree. In this case, if sorting is performed according to the due date, the sorting position of these tasks may be later, which is not conducive to the first user viewing the information of the task intuitively. In view of this, in an implementation of the embodiment of the present disclosure, the first user may adjust display positions of some or all of the tasks. Taking the first task as an example, the first user may trigger a position moving operation for the first task. For example, the first task is dragged to a target position. After the first user triggers the position moving operation for the first task, the client may modify the display position of the first task on the first page in response to the position moving operation. After the display position of the first task on the first page is modified, when the user visits the page for presenting the information of the task related to the user next time, the first task is displayed on the page displayed by the client at the position after the aforementioned modification, so that the user can intuitively check the information of the first task.

The first page may be understood in conjunction with FIG. 13, which is a schematic diagram of a first page according to an embodiment of the present disclosure.

As shown in FIG. 13, information of multiple tasks related to the first user is displayed on the first page. The information of the multiple tasks is presented in the form of a list, and information of one task corresponds to one record in the list. The information of the multiple tasks is sorted based on the due dates of respective tasks in a reverse order. The header of the list includes: Summary information, Creator, Executor, Status, Label, and Due date.

In an example, the first user may drag the task corresponding to “Test 3” to a position in front of the task corresponding to “Test 1”, so as to change the display position of the task corresponding to “Test 3” on the first page.

In an example, it is considered that there are many tasks related to the first user, and the first user may concern some of the tasks. Therefore, in an example, the target application may further support a task screening function. In an embodiment, the first user may trigger the task screening operation on the first page. After the first user triggers the task screening operation, the client may obtain a screening condition in least one dimension in response to the task screening operation, determine a task that meets the screening condition from the at least one task, and display information of the task obtained through screening.

In an example, the first page may include a task screening control. After the first user triggers the task screening control (for example, clicks on the task screening control), the client may display a task screening page. The first user may edit the screening condition in at least one dimension on the task screening page. Then, the client may obtain the screening condition in the at least one dimension.

It should be noted that at least one dimension mentioned here may be one or more of a label, a creator, an executor, a due date, and a status. For example, the first user may set the screening condition as: finished, and the executor being user A. As another example, the first user may set the screening condition as: unfinished, and the due date before *year*month*day. For another example, the first user may set the screening condition as: #A. Examples of the screening condition will not be listed and explained one by one here.

It should be noted that, among the at least one task, the first task with the first label may be pre-created by the user. Next, an implementation of creating the first task and adding a label to the first task will be introduced.

In an embodiment of the present disclosure, if the first label is created first, the user may trigger a task creating operation on a page related to the first label, to create the first task with the first label.

In an example, the task creating operation may be triggered on an overview page of the first label. After the user triggers the task creating operation, the client may create the first task in response to the task creating operation. In an embodiment, after the user triggers the task creating operation, the client may display a task creation page, and obtain task information inputted by the user on the task creation page, to create the first task. The user mentioned here may be the aforementioned first user, or may be a second user different from the first user, which is not limited here. It is to be understood that, if the user mentioned here is the aforementioned first user, the first user is the creator of the first task.

Regarding the overview page of the first label, it should be noted that the overview page of the first label is a page for separately displaying information of respective information fields of the first label. The respective information fields include, but are not limited to, one or more of: task, cloud file, message, schedule, and group. In an embodiment, on the client of the first user, the overview page of the first label is configured to display information of respective information fields that has the first label and for which the first user has a viewing permission. The overview page may include multiple display areas. One of the multiple display areas is configured to display information in one of the information fields. The information field in the embodiments of the present disclosure is used to provide information of a certain type. One information field may correspond to one service provider.

In an example, the task creating operation may be triggered on a page corresponding to a task information field of the first label. After the user triggers the task creating operation, the client may create the first task in response to the task creating operation. In an embodiment, after the user triggers the task creating operation, the client may display a task creating page and obtain task information inputted by the user on the task creating page, to create the first task. The user mentioned here may be the aforementioned first user, or may be a second user different from the first user, which is not limited here. It is to be understood that, if the user mentioned here is the aforementioned first user, the first user is the creator of the first task.

Regarding the page corresponding to the task information field of the first label, it should be noted that the page corresponding to the task information field of the first label is configured to display information of a task with the first label. In an embodiment, the page corresponding to the task information field of the first label is configured to display task information that has the first label and for which the first user has permission to view; on the client of the first user.

In an embodiment of the present disclosure, if the first task is created first, the user may trigger a label adding operation on the page corresponding to the first task, to add the first label to the first task. The user mentioned here may be the aforementioned first user, or may be a second user different from the first user, which is not limited here.

In an example, after the user triggers the label adding operation on the page corresponding to the first task, the client may respond to the label adding operation and obtain the first label corresponding to the label adding operation, and further store an association relationship between the first task and the first label, so as to add the first label to the first task.

In an implementation, after the user triggers the label adding operation on the page corresponding to the first task, the client may display a character input area in response to the label adding operation. Then, the user may input a character in the character input area. The user may input at least a part of characters included in the first label in the character input area. Correspondingly, after the client obtains the character inputted by the user, the client may provide the user with corresponding label candidates according to the character inputted by the user, and display the label candidates. The user can select the first label from the label candidates. After the user selects the first label, that is, the user triggers a selecting operation for the first label among the label candidates, for example, clicks on the first label, the client may obtain the first label, and further store the association relationship between the first task and the first label.

In another implementation, after the user triggers a label adding operation on the page corresponding to the first task, the client may display at least one label candidate in response to the label adding operation. After the at least one label candidate is displayed, the user may trigger a selecting operation for one of the at least one label candidate. If the user triggers the selecting operation for the first label among the at least one label candidate, such as clicking on the first label, the client may obtain the first label, and further store the association relationship between the first task and the first label.

It should be noted that, in consideration of a usage permission for the label, only when the user has the usage permission for a certain label, the user is allowed to add the label to information. Therefore, in an example, the at least one label candidate may be a candidate that the user has permission to use.

As mentioned above, the page corresponding to the task information field of the first label is configured to display the information of the task with the first label. In one example, it is considered that for a task, the label of the task may change with time. For example, a task A is originally associated with a project 1 and a project 2. With the progression of the project, the task A is no longer associated with the project 1. In this case, it is not suitable for the task A to have the label corresponding to a correspondence 1 (for example, the first label).

Considering this situation, in an embodiment of the present disclosure, the user may trigger a label cancelling operation on the page corresponding to the task information field of the first label. Correspondingly, the client may respond to the label cancelling operation, to delete the association relationship between the first task and the first label. It is to be understood that after the association relationship between the first task and the first label is deleted, the overview page of the first label no longer presents the information of the first task. Correspondingly, the information of the first task is not displayed, on the page corresponding to the task information field of the first label.

It is to be understood that in the case that the first task has only one label which is the first label, after the association relationship between the first task and the first label is deleted, the aforementioned first page is refreshed, then the first page after the refresh does not include the information of the first task. In the case that the first task includes another label in addition to the first label, after the association relationship between the first task and the first label is deleted, the first page is refreshed, then the first page after the refresh may include the information of the first task, and the label of the first task does not include the first label.

An information processing method is further provided according to and embodiment of the present disclosure, which is described below with reference to the accompanying drawings.

Reference is made to FIG. 14, which is a flowchart of an information processing method according to an embodiment of the present disclosure.

Similar to the task-based information processing method shown in FIG. 12, the information processing method shown in FIG. 14 may also be executed by a client. The schedule creating method shown in FIG. 14 may include, for example, the following steps S1401-S1403.

In step S1401, a first information adding page is displayed in response to an information adding operation triggered by a user for a first information field, where the first information adding page includes identifiers of multiple information fields, and the multiple information fields include a first information field and a second information field.

In an embodiment of the present disclosure, the user may trigger the information adding operation for the first information field on a page displayed by a client of the user. For example, the page displayed by the client may include a first control configured to trigger the information adding operation for the first information field. The user may, for example, click on the first control to trigger the information adding operation for the first information field.

In an example, the user may trigger the information adding operation for the first information field on the overview page of the first label. The overview page of the first label may refer to the relevant description above, and no repeated description is made here.

In an embodiment of the present disclosure, after the user triggers the information adding operation for the first information field, the client may display the first information adding page in response to the information adding operation. The first information adding page may include identifiers of multiple information fields, and the multiple information fields include at least a first information field and a second information field.

The first information field and the second information field may be different information fields. The first information field may be one of a task, a cloud file, a message, a schedule, and a group, and the second information field may also be one of a task, a cloud file, a message, a schedule, and a group. For example, the first information field is a schedule, and the second information field is a cloud file. For another example, the first information field is a task, and the second information field is a cloud file, which are not listed here.

In an example, the first information adding page presented by the client in response to the information adding operation for the first information field not only includes the identifiers of the multiple information fields, but also presents at least one piece of candidate information corresponding to the first information field by default. The first user may trigger a selecting operation on one or more pieces of candidate information among the at least one piece of candidate information corresponding to the first information field, to add information corresponding to the one or more pieces of the first information field. It should be noted that, in an example, the user has a viewing permission for the at least one piece of candidate information corresponding to the first information field.

In step S1402, candidate information corresponding to the second information field is displayed in response a selecting operation triggered by the user for the identifier of the second information field, where the second information field is different from the first information field.

In step S1403, in response to a selecting operation triggered by the user for at least one piece of information in the candidate information, an association relationship between the at least one piece of information and a first label is generated.

In an embodiment of the present disclosure, the first information adding page includes the identifier of the second information field. If the user is to add information corresponding to the second information field, the user may trigger the selecting operation for the identifier of the second information field. After the user triggers the selecting operation for the identifier of the second information field, the client may display the candidate information corresponding to the second information field in response to the selecting operation triggered by the user for the identifier of the second information field. It should be noted that, in an example, the user has a viewing permission for the candidate information corresponding to the second information field.

Then, the user may trigger a selecting operation for at least one piece of information in the candidate information of the second information field. The client may generate a correspondence between the at least one piece of information and the first label, in response to the selecting operation triggered by the user for the at least one piece of information in the candidate information of the second information field. In this way, the purpose of adding at least one piece of information corresponding to the second information field is achieved.

With this solution, even if the user triggers an information adding operation for the first information field, the information in the second information field that has the first label may be added. In this way, the page displayed by the client, such as the overview page of the first label, does not need to include a control for triggering an information adding operation for each information field, but only needs to include the first control. The number of control included on the page displayed by the client is reduced, and the layout of the page displayed by the client is more concise.

With regard to the method shown in FIG. 14, the page displayed by the client being the overview page of the first label is described as an example in conjunction with FIGS. 15a to 15c. FIG. 15a is a schematic diagram of an overview page of a first label according to an embodiment of present disclosure, FIG. 15b is a schematic diagram of an information adding page according to an embodiment of present disclosure, and FIG. 15c is a schematic diagram of an information adding page according to another embodiment of present disclosure.

As shown in FIG. 15a, the overview page of the first label “M” includes information of respective information fields with the first label. The first information field may be a schedule. The user may trigger the information adding operation for the schedule through a control “add immediately” shown in FIG. 15a. After the user triggers the information adding operation for the schedule, the client may display the information adding page shown in FIG. 15b. The information adding page includes identifiers of the information fields (names of the information fields shown in FIG. 15b), and information candidates corresponding to the schedule: schedules A to E. After the user triggers a selecting operation for the second information field, such as “cloud file”, for example, the user clicks “cloud file” in FIG. 15b, the client may display the information adding page shown in FIG. 15c. The information adding page shown in FIG. 15c includes information candidates corresponding to the cloud file: cloud files 1 to 5. If the user triggers a selecting operation for the cloud file 1, the client may generate a correspondence between the label M and the cloud file 1.

It should be noted that, after performing the above steps S1401-S1403, the client may further display the at least one piece of information on the page corresponding to the second information field of the first label. The page corresponding to the second information field of the first label is configured to present information having the first label and corresponding to the second information field. For example, if the second information field is cloud file, the page corresponding to the second information field of the first label is used to present the cloud file with the first label. In an example, on the client of the first user, the page corresponding to the second information field of the first label is used to present information that has the first label, that corresponds to the second information field, and for which the first user has a viewing permission.

In an example, the user may further trigger an information adding operation for the first information field on the overview page of the first label, to add information having the first label and corresponding to the first information field. The detailed process is described as follows.

After the user triggers the information adding operation for the first information field on the overview page of the first label, the client may display a second information adding page in response to the information adding operation. The second information adding page may include, for example, an editing area for editing information corresponding to the first information field. After the second information adding page is displayed, the user may edit the information corresponding to the first information field in the editing area of the second information adding page. For example, the user may edit first information in the editing area of the second information adding page. In this way, the client obtains the first information, and further generates a correspondence between the first information and the first label.

After the client generates the correspondence between the first information and the first label, the client may further display the first information on the overview page of the first label. For example, the first information may be displayed in a display area corresponding to the first information field on the overview page. In addition, the client may display the first information on a page corresponding to the first information field of the first label. The page corresponding to the first information field of the first label is configured to present information having the first label and corresponding to the first information field. In an example, if the user is the owner of the first label, the user may further trigger a collaborator editing operation on the overview page of the first label to edit a collaborator of the first label. The collaborator of the first label refers to a user who has the viewing permission for the first label. If the user has the viewing permission for the first label, the user has the permission to view associated information of the first label. The associated information of the first label refers to the information of respective information fields of the first label.

In an embodiment of the present disclosure, after the user triggers the collaborator editing operation, the client may obtain information of an edited collaborator and generate a correspondence between the edited collaborator and the first label, in response to the collaborator editing operation.

The collaborator editing operation mentioned here may include three operations, including: a collaborator adding operation, a collaborator deleting operation, and a collaborator modifying operation. The collaborator adding operation is used to add a new collaborator on the basis of an original collaborator. The collaborator deleting operation is used to delete some or all of the original collaborators. The collaborator modifying operation is used to modify some or all of the original collaborators, such as changing a first collaborator to a second collaborator.

It should be noted that the collaborator editing operation triggered by the user on the overview page may be implemented in multiple ways. In an example, the overview page may include a collaborator editing control. After the user triggers the control, the client displays a collaborator editing page. The user may trigger one or more of the collaborator adding operation, the collaborator deleting operation and the collaborator modifying operation on the collaborator editing page. In yet another example, the overview page may include multiple controls, which includes a collaborator adding control, a collaborator deleting control, and a collaborator modifying control. A user may trigger a collaborator adding operation through the collaborator adding control, trigger a collaborator deleting operation through the collaborator deleting control, and trigger a collaborator modifying operation through the collaborator modifying control.

As mentioned above, the overview page of the first label displays the information of respective information fields having the first label in different regions. In an example, the overview page of the first label displays the number of pieces of information with the first label in each information field. As can be understood with reference to FIG. 15a, the number of tasks corresponding to the task information field is 3, the number of cloud files corresponding to the cloud file information field is 5, the number of message corresponding to the message information field is 1, and the number of group corresponding to the group information field is 1, and the number of schedule corresponding to the schedule information field is 1.

Considering that the content that can be presented on the overview page is limited, for the first information field among the respective information fields, the information may not be completely displayed on the overview page. In order to facilitate the user checking detailed information in the first information field, if the user wishes to view the detailed information in the first information field, the user may trigger a preset operation for the number of pieces of information corresponding to the first information field. For example, the user may click on the number of pieces of information corresponding to the first information field. In this way, the client may display the page corresponding to the first information field of the first label, in response to the preset operation triggered by the user for the number of pieces of information corresponding to the first information field. Thus, the user can view the detailed information in the first information field.

In an example, if the user wishes to view certain information on the overview page, such as the second information, the user may trigger a preset operation for the second information on the overview page. For example, the user may click on the information summary of the second information displayed on the overview page to view the second information.

In some embodiments, after the preset operation triggered by the user for the second information on the overview page, the client may jump to a page including the second information, in response to the preset operation triggered by the user for the second information on the overview page. In this way, the user can view the second information. For example, if the second information is a group, the client may jump to a page of the group. For another example, if the second information is a message, the client may jump to an instant messaging page including the message. For another example, if the second information is a schedule, the client may jump to a page of the schedule.

In some other embodiments, after the preset operation triggered by the user for the second information on the overview page, the client may display the second information, in response to the preset operation triggered by the user for the second information on the overview page. The second information mentioned here refers to information for which the user has a viewing permission. As an example, the second information may be displayed in a browser. As an example, the second information may be displayed in a first area (such as a sidebar) of the overview page. The second information is not limited in the embodiments of the present disclosure, and the second information may be any one of a task, a cloud file, a message, a schedule, and a group. In an example, in the case that the second information is an instant messaging message, after the preset operation triggered by the user for the second information on the overview page, the client displays contextual information of the second information in addition to the second information. Thus, the user can view the second information and the contextual information of the second information.

It should be noted that, in the case that the second information is a group, implementations of displaying the second information in the first area of the overview page may include, for example, displaying summary information (such as a name) of the group, and displaying an instant messaging interface corresponding to the group in the first area.

If the client displays the instant messaging interface corresponding to the group in the first area of the overview page, then when the user is in the group, the user may conduct an instant messaging conversation in the first area, rather than jumping to the instant messaging interface of the group. In an embodiment, the user may input an instant messaging message in the first area. The client may display the instant messaging message in the instant messaging interface on reception of the instant messaging message inputted by the user. In addition, if other users in the group publish instant messaging messages in the group, the client may further display the instant messaging messages published by the other users in the first area.

In some embodiments, after the preset operation triggered by the user for the second information on the overview page, the client jumps to a page including the second information. In order to quickly switch the page displayed by the client from the page including the second information to the overview page, the user may trigger a preset operation on the page including the second information. Correspondingly, the client may display the overview page in response to the preset operation triggered by the user on the page including the second information. Therefore, the page displayed by the client is quickly switched to the overview page. In an example, the page including the second information may further include a second control. The preset operation triggered by the user on the page including the second information may be, for example, clicking on the second control.

Based on the method according to the above embodiments, a corresponding apparatus is further provided according to an embodiment of the present disclosure, which is described below with reference to the accompanying drawings.

FIG. 16 is a schematic structural diagram of a task-based information processing apparatus according to an embodiment of the present disclosure. Referring to FIG. 16, the apparatus 1600 may include a first obtaining unit 1601 and a first display unit 1602.

The first obtaining unit 1601 is configured to obtain at least one task that is associated with a first user and that has a label, where the label is an additional attribute of the at least one task, and is shared within a preset range determined by a permission for the label.

The first display unit 1602 is configured to display information corresponding to the at least one task on a first page, where the first page is displayed on a client logging in to an account of the first user.

In an embodiment, the task associated with the first user includes any one or more of: a task with a creator being the first user, a task with an executor being the first user, and a task concerned by the first user.

In an embodiment, the at least one task includes a first task, and information of the first task includes any one or more of: a label of the first task, a creator of the first task, an executor of the first task, a due date of the first task, a status of the first task, and summary information of the first task.

In an embodiment, information corresponding to the at least one task is displayed on the first page in a form of a list, and the information of one task corresponds to one of records in the list, and a header of the list indicates content included in the information of the at least one task.

In an embodiment, the apparatus further includes: a first determining unit configured to determine content in the information of the at least one task that is displayed on the first page, in response to a task information selecting operation triggered by the first user for the header.

In an embodiment, the information of the at least one task is sorted based on a due date of the at least one task in a reverse order.

In an embodiment, the apparatus further includes: a modification unit configured to modify a display position of a first task among the at least one task on the first page in response to a position moving operation triggered by the first user for the first task.

In an embodiment, the apparatus further includes: a second obtaining unit, a second determining unit and a second display unit.

The second obtaining unit is configured to obtain a screening condition in at least one dimension, in response to a task screening operation triggered by the first user.

The second determining unit is configured to determine a task that meets the screening condition, from the at least one task.

The second display unit is configured to display information of the task obtained through screening.

In an embodiment, the least one dimension includes: a label, a creator, an executer, a due date, and a status.

In an embodiment, the at least one task includes a first task with a first label, and the apparatus further includes a creating unit configured to: create the first task in response to a task creating operation triggered by the user on an overview page of the first label, where the overview page of the first label is configured to display information of respective information fields with the first label in different regions: or create the first task in response to a task creating operation triggered by the user on a page corresponding to a task information field of the first label, where the page corresponding to the task information field is configured to display information of a task with the first label.

In an embodiment, the at least one task includes a first task with a first label, and the apparatus further includes: a third obtaining unit and a storing unit.

The third obtaining unit is configured to obtain, in response to a label adding operation triggered by the user on a page corresponding to the first task, the first label corresponding to the label adding operation.

The storing unit is configured to store an association relationship between the first task and the first label.

In an embodiment, the at least one task includes a first task with a first label, and the apparatus further includes: a deleting unit configured to delete an association relationship between the first task and the first label, in response to a label cancelling operation triggered by the user on the page corresponding to the task information field of the first label, where after the association relationship between the first task and the first label is deleted, the overview page of the first label and the page corresponding to the task information field do not include the first task.

For implementations of the functions of respective units of the apparatus 1600, reference can be made to the above description of the method shown with reference to FIG. 12, and no repeated description is made here.

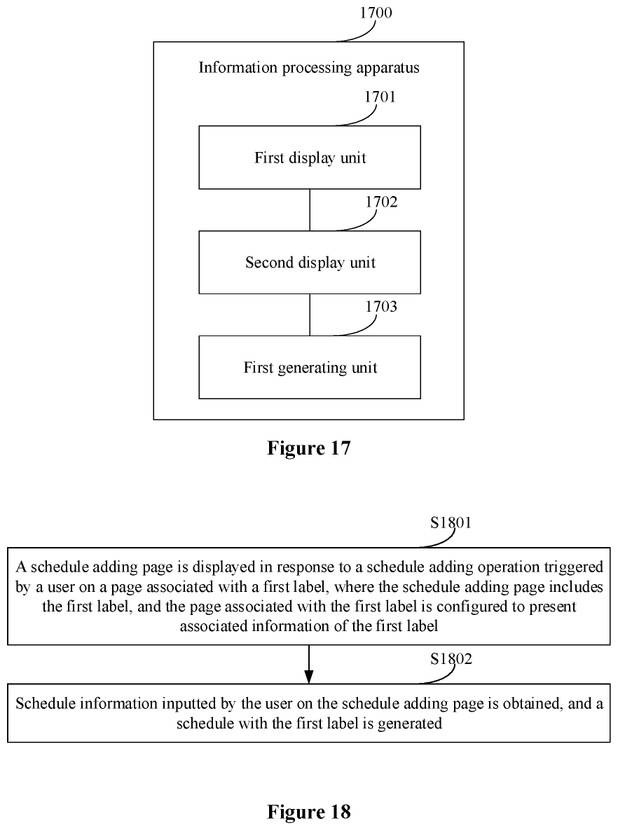

FIG. 17 is a schematic structural diagram of an information processing apparatus according to an embodiment of the present disclosure. Referring to FIG. 17, the apparatus 600 may include a first display unit 1701, a second display unit 1702, and a first generating unit 1703.

The first display unit 1701 is configured to display a first information adding page in response to an information adding operation triggered by a user for a first information field, where the first information adding page includes identifiers of multiple information fields, and the multiple information fields include a first information field and a second information field.

The second display unit 1702 is configured to display candidate information corresponding to the second information field in response a selecting operation triggered by the user for the identifier of the second information field, where the second information field is different from the first information field.

The first generating unit 1703 is configured to generate, in response to a selecting operation triggered by the user for at least one piece of information in the candidate information, an association relationship between the at least one piece of information and a first label.

In an embodiment, the information adding operation triggered by a user for a first information field includes: the information adding operation for the first information field triggered by the user on an overview page of the first label, where the overview page of the first label is configured to display information of respective information fields with the first label in different regions.

In an embodiment, in the first information adding page that is displayed in response to the information adding operation for the first information field, candidate information corresponding to the first information field is presented by default.

In an embodiment, the apparatus further includes: a third display unit configured to display the at least one piece of information on a page corresponding to the second information field of the first label.

In an embodiment, the apparatus further includes: a fourth display unit, a first obtaining unit and a second generating unit.

The fourth display unit is configured to display a second information adding page in response to the information adding operation for the first information field triggered by the user on an overview page of the first label, where the overview page of the first label is configured to display information of respective information fields with the first label in different regions.

The first obtaining unit is configured to obtain first information that corresponds to the first information field and is added by the user on the second information adding page.

The second generating unit is configured to generate an association relationship between the first information and the first label.

In an embodiment, the apparatus further includes: a fifth display unit and a sixth display unit.

The fifth display unit is configured to display the first information on the overview page.

The sixth display unit is configured to display the first information on a page corresponding to the first information field of the first label.

In an embodiment, the apparatus further includes: a second obtaining unit configured to obtain information of an edited collaborator, in response to a collaborator editing operation triggered by the user on the overview page: and generate a correspondence between the edited collaborator and the first label.

In an embodiment, the collaborator modifying operation includes: a collaborator adding operation, a collaborator deleting operation, or a collaborator modifying operation, where the collaborator modifying operation is used to modify a first collaborator to a second collaborator.

In an embodiment, the number of pieces of information with the first label in each of the multiple information fields is displayed on the overview page of the first label, and the multiple information fields comprise the first information field; and the apparatus further includes: a seventh display unit configured to display a page corresponding the first information field of the first label, in response to a preset operation triggered by the user for the number of pieces of information corresponding to the first information field, where the page corresponding to the first information field includes an information summary of information that has the first label and corresponds to the first information field.

In an embodiment, the apparatus further includes: a jumping unit or an eighth display unit.

The jumping unit is configured to jump to a page including the second information, in response to a preset operation triggered by the user for second information in an overview page of the first label.

The eighth display unit is configured to display the second information, in response to a preset operation triggered by the user for the second information in the overview page, where the user has a viewing permission for the second information.

The overview page of the first label is configured to display information of respective information fields with the first label in different regions.

In an embodiment, the second information is an instant messaging message, and the apparatus further includes: a presenting unit configured to present contextual information of the second information.

In an embodiment, the apparatus further includes: a ninth display unit configured to display the overview page, in response to a preset operation triggered by the user on a page including the second information.

In an embodiment, the second information is a group, and the eighth display unit is configured to: display an instant messaging interface corresponding to the group in a first area of the overview page.

In an embodiment, the apparatus further includes: a receiving unit and a tenth display unit.

The receiving unit is configured to receive an instant messaging message inputted by the user in the first region, where the user is in the group.

The tenth display unit is configured to display the instant messaging message in the instant messaging interface.

In an embodiment, the first information field is any one of: a task, a cloud file, a message, a schedule, and a group.

The second information field is any one of: a task, a cloud file, a message, a schedule, and a group.

For implementations of the functions of respective units of the apparatus 1700, reference can be made to the above description of the method shown with reference to FIG. 14, and no repeated description is made here.

A device is further provided according to an embodiment of the present disclosure. The device includes a processor and a memory. The processor is configured to execute instructions stored in the memory, to cause the device to implement the task-based information processing method or the information processing method according to the above method embodiments.

A computer-readable storage medium including instructions is further provided according to an embodiment of the present disclosure. The instructions instruct a device to implement the task-based information processing method or the information processing method according to the above method embodiments.

A computer program product is further provided according to an embodiment of the present disclosure. The computer program product, when running on a computer, causes the computer to execute the task-based information processing method or the information processing method according to the above method embodiments.

In some scenarios, a schedule with a label needs to be created. For example, for a certain project, a label may be added to a schedule related to the project. Participants of the project may locate the schedule related to the project through the label, so that the participants of the project can reasonably arrange their work schedules. However, in the current way of creating a schedule with a label, user operations are cumbersome. For example, for a certain project, a label may be added to a schedule related to the project. In an example, project participants related to the schedule may be given a permission for the label, and the project participants related to the schedule may be given an access permission for the schedule. In this way, project participants related to the schedule may locate the schedule through the label, so as to arrange their work schedules reasonably.

However, in the current way of creating a schedule with a label, user operations are cumbersome. As an example, first a schedule needs to be created, and then a corresponding label is added to the schedule.

In order to solve the above problem, a method and an apparatus for creating a schedule are provided according to the embodiments of the present disclosure.

Various non-limiting implementations of the present disclosure will be described in detail below with reference to the accompanying drawings.

FIG. 18 is a flow chart of a schedule creating method according to an embodiment of the present disclosure.

The method according to the embodiments of the present disclosure may be executed by a client or a server. In an embodiment of the present disclosure, a target application may be installed on the client, and the server may be a server-side corresponding to the target application. A user mentioned in the embodiments of the present disclosure refers to a user logging into the account of the target application on the client.

In the following description of the embodiments of the present disclosure, the method being executed by the client is taken as an example for illustration.

The “#” in the drawings of the embodiments of the present disclosure is a label identifier. Of course, the label identifier is not limited to “#”, which may be other symbols.

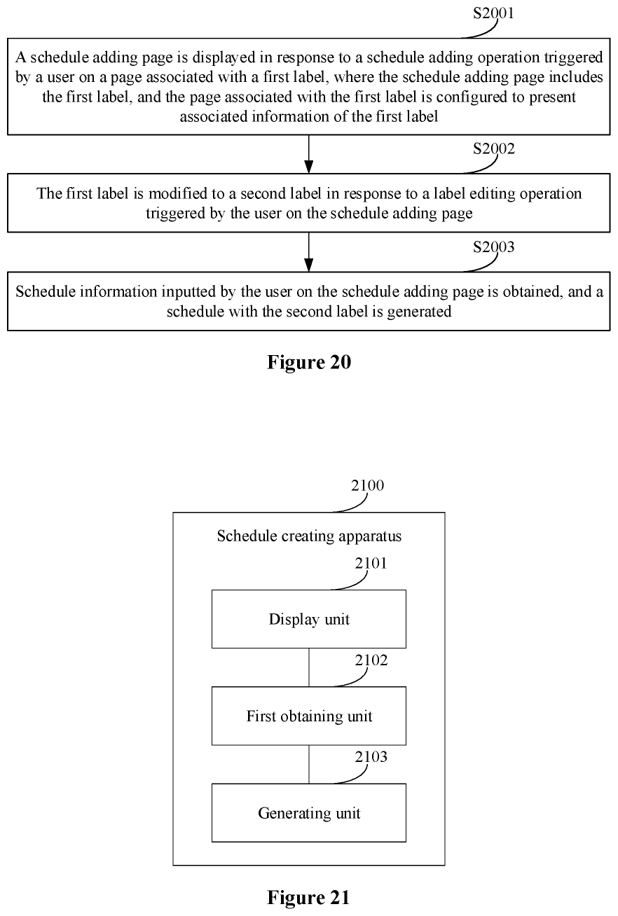

The following method shown in FIG. 18 and the method shown in FIG. 20 may be combined and referred to each other if there is no contradiction.

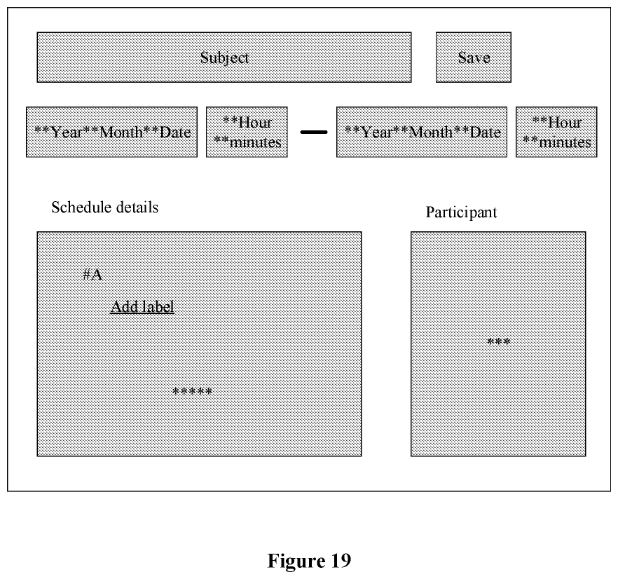

All the drawings in the embodiments of the present disclosure, such as FIG. 19, is shown for the convenience of understanding the content related to the embodiments of the present disclosure, and do not constitute a limitation to the embodiments of the present disclosure. The pages shown in FIG. 19 may further include other content, which is not limited in the embodiments of the present disclosure.

In this embodiment, the method shown in FIG. 18 may for example include the following steps S1801-S1802.

In step S1801, a schedule adding page is displayed in response to a schedule adding operation triggered by a user on a page associated with a first label, where the schedule adding page includes the first label, and the page associated with the first label is configured to present associated information of the first label.

In an embodiment of the present disclosure, the associated information of the first label refers to information that is associated with the first label. The information mentioned here includes, but is not limited to, one or more of a task, a schedule, a message, a cloud file, and a group. The task, the schedule, the message, the cloud file, and the group may correspond to respective information fields. In an embodiment, the task may correspond to a task information field, the schedule may correspond to a schedule information field, a message may correspond to a message information field, and the cloud file may correspond to a cloud file information field, the group may correspond to the group information field. The information field in the embodiment of present disclosure is used to provide information of a certain type. In some application scenarios, one information field may correspond to one service provider.

In an implementation of the embodiment of the present disclosure, the page associated with the first label may be an overview page of the first label. The overview page of the first label collectively displays information of respective information fields with the first label. In an example, the overview page of the first label may include information of respective information fields with the first label, for example, including one or more of: information of the task information field, information of the schedule information field, information of the message information field, information of the cloud file information field and information of the group information field. In some embodiments, in order to facilitate the user viewing the information included in the overview page, information corresponding to respective information fields is presented in different regions on the overview page. For example, in the overview page, the task information field, the schedule information field, the message information field, the cloud file information field, and the group information field correspond to respective display areas for displaying corresponding information. That is, the display area corresponding to the task information field is used to display information of a task with the first label. The display area corresponding to the schedule information field is used to display information of a schedule with the first label. The display area corresponding to the message information field is used to display information of a message with the first label. The display area corresponding to the cloud file information field is used to display information of a cloud file with the first label. The display area corresponding to the group information field is used to display information of a group with the first label.

In another implementation of the embodiment of the present disclosure, the page associated with the first label may be a page corresponding to the schedule information field of the first label. The page corresponding to the schedule information field of the first label is used to display information of a schedule with the first label. The page corresponding to the schedule information field may also be referred to as a “schedule page”.

In an example, the user has a viewing permission for content displayed on the page which is associated with the first label and is displayed on the client of the user.

In an implementation of the embodiment of the present disclosure, the page associated with the first label may include a first control. A function corresponding to the first control is a schedule adding function. The user may trigger a schedule adding operation through the first control. After the user triggers the schedule adding operation, the client may display a schedule adding page, and the schedule adding page may automatically bring with the first label.

In an example, in an implementation of step S1801, the client may, for example, first call a schedule application programming interface (API), and transmit the first label as a parameter to the schedule application through the schedule API, so as to obtain the aforementioned schedule adding page including the first label. The schedule application is a software module for creating a schedule.

In step S1802, schedule information inputted by the user on the schedule adding page is obtained, and a schedule with the first label is generated.

After the schedule adding page is displayed, the user may input schedule information on the schedule adding page. The schedule information includes, for example, detailed information such as a subject of the schedule, start time and end time of the schedule, and a corresponding meeting room.

After the user inputs schedule information on the schedule adding page, the client may obtain the schedule information inputted by the user, and further generate a schedule with the first label based on the obtained schedule information. It is to be understood that the generated schedule includes the schedule information obtained by the client.

It can be seen from the above description that, with the schedule creating method shown in FIG. 18, after the user triggers the schedule adding operation on the page associated with the first label, the first label may be automatically brought into the schedule adding page. Further, the schedule with the first label may be generated. There is no need for the user to create a schedule, and then add the first label to the schedule, thereby reducing the cumbersome operations for creating a schedule having a label.

In an example, after the schedule with the first label is created, summary information of the schedule may be presented on the schedule page of the first label. The summary information of the schedule mentioned here may be, for example, the subject of the schedule, or a keyword in the subject of the schedule, which is not limited here. The schedule page corresponding to the first label is used to display summary information of the schedule with the second label. In some embodiments, summary information of a schedule for which the user has a viewing permission may be displayed on the schedule page which corresponds to the first label and is displayed on the client.

In an example, multiple labels may be added to a schedule. In this case, the user may trigger a label editing operation on the schedule adding page. For example, the schedule adding page includes a label adding control, and the user may trigger the label editing operation through the label adding control. After the user triggers the label editing operation, the client may obtain a second label indicated by the label editing operation. Correspondingly, the schedule generated by the client may have a second label in addition to the aforementioned first label.

It is to be understood that, if the schedule further has a second label, summary information of the schedule may be presented on a schedule page of the second label. The schedule page corresponding to the second label is configured to display summary information of a schedule with the second label. In some embodiments, summary information of a schedule for which the user has a viewing permission may be displayed, on the schedule page which corresponds to the second label and is displayed on the client.

In an embodiment of the present disclosure, the second label may be obtained in response to the label editing operation triggered by the user on the schedule adding page in multiple ways. Two possible implementations are described below.

The first implementation includes the following steps.

After the user triggers the label editing operation on the schedule adding page, the client may display at least one label candidate in response to the label editing operation. After the at least one label candidate is displayed, the user may trigger a selecting operation for one of the at least one label candidate. If the user triggers the selecting operation for the second label among the at least one label candidate, for example, the user clicks on the second label, the client may obtain the second label.

It should be noted that, in consideration of a usage permission for the label, only when the user has the usage permission for a certain label, the user is allowed add the label to information. Therefore, in an example, the user may have a usage permission for the at least one label candidate.

The second implementation includes the following steps.

After the user triggers the label editing operation on the schedule adding page, the client may display a character input area in response to the label editing operation. Then, the user may input a character in the character input area. The user may input at least a part of characters included in the second label, in the character input area. Correspondingly, after obtaining the character inputted by the user, the client may provide the user with one or more corresponding label candidates according to the character inputted by the user, and display the label candidates, so that the user may select the second label from the label candidates. The user selects the second label, that is, the user triggers the selecting operation for the second label among the label candidates. For example, the user clicks on the second label. Then, the client may obtain the second label.

In some embodiments, it is considered that the schedule generally has a corresponding participant. The first label may have an identification meaning, for example, the first label is related to a certain item. Correspondingly, the first label also has a collaborator. The collaborator of the first label refers to a user having a permission for the first label, for example, a user having a viewing permission for the first label. The user having the viewing permission for the first label has a permission to view associated information of the first label. Since the schedule has the first label, in some scenarios, the collaborator of the first label may be a participant of the schedule by default. Therefore, in an example, the aforementioned schedule adding page may further include a participant of the schedule, which is a user having the permission for the first label. In other words, the collaborator of the first label may be automatically brought into the schedule adding page. In this way, the user is not required to manually input the participant of the schedule, which improves the efficiency of creating the schedule.

In other embodiments, the participant of the schedule may be specified by the user. For this case, the user may input the participant of the schedule on the schedule adding page.

It should be noted that, the participant of the schedule inputted by the user may include the collaborator of the first label, and may also include a user other than the collaborator of the first label. In some application scenarios, in the case that the participant of the schedule inputted by the user includes a user other than the collaborator of the first label, after the schedule having the first label is generated, the participant of the schedule other than the collaborator of the first label among the participants of the schedule may be modified to a collaborator of the first label. In other words, after the schedule having the first label is generated, the client may grant the permission for the first label to the participant of the schedule, in response to the generation of the schedule having the first label. In an embodiment, the permission for the first label may be granted to a user originally without the permission for the first label among the participants of the schedule. The permission for the first label mentioned here may be the viewing permission for the first label. The viewing permission for the first label refers to a permission to view the associated information of the first label, for example, which indicates whether the client used by the user is allowed to display the first label and at least a part of the information with the first label in an association manner. The associated information of the first label mentioned here refers to the information with the first label.

For example, the user inputs participants of the schedule, including a user A and a user B, where the user B is not a collaborator of the first label. After the schedule is generated, the user B may be given the viewing permission for the first label, such that the user B is the collaborator of the first label. In this way, the user can directly set the user B as the participant of the schedule, rather than first modifying the user B as a collaborator of the first label and then setting user B as the participant of the schedule. The operation is flexible, and the user operation is simplified to improve the user experience. Further, in the scenario where the first label corresponds to a project that multiple people collaborate on, for a user B having the viewing permission for the schedule, even if the user B currently does not have the viewing permission for the first label, for example, the user B is a new user that currently participants in the project, the user B can be quickly set as a participant of the schedule, and automatically set as a collaborator of the first label with this method, rather than additionally setting the user B as a collaborator of the first label. Thus, a flexible operation is provided and the user experience is improved.

The schedule adding page is described with reference to FIG. 19, which is a schematic diagram of a schedule adding page according to an embodiment of the present disclosure.

As shown in FIG. 19, #A represents the first label, and “Add Label” is a label adding control. The participant of the label, as mentioned above, may be a collaborator of the first label, or may be inputted by the user. For example, the participant of the label is indicated by “***” in the area indicating “participant”” in FIG. 19. Other content in detailed information of the label, such as a corresponding meeting room, a schedule reminder manner, and the like, for example, may be indicated by “*****” in the area indicating “schedule details” in FIG. 19. After the user inputs the schedule information on the schedule adding page, the user may click the “Save” control shown in FIG. 19 to generate the schedule with the first label.

It should be noted that, in the embodiments of the present disclosure, the label is not limited to be used only locally on the client of the first user. The label may be shared within a certain range. In an embodiment, the sharing range of the label may be determined by the permission for the label.

In an example, the permission for the first label may include a usage permission. The usage permission refers to a permission to add the first label to an information unit. In an embodiment, a user having the use permission for the first label is allowed add the first label to an information unit on a client corresponding to the user. The use permission for the first label may be set by the owner of the first label, and the owner of the first label may designate a user that has the use permission for the first label.

In another example, the permission for the first label includes a viewing permission. The viewing permission refers to a permission to view the associated information of the first label. In an embodiment, the associated information of the first label is displayed on the client of the user that has the viewing permission for the first label. In other words, the user having the viewing permission for the first label can view the associated information of the first label on the client corresponding to the user. The viewing permission for the first label may be set by the owner of the first label, and the owner of the first label may designate a user that has the viewing permission for the first label.

In some embodiments, it is considered that the information unit itself also has a viewing permission. Then, for the first user that has the viewing permission for the first label, the associated information of the first label displayed on the client of the first user may be the information for which the first user has the viewing permission. In other words, the associated information of the first label presented on the client of the first user does not include the information for which the first user does not have the viewing permission. In this way, information security can be effectively protected, and information leakage caused by the first user viewing information for which he does not have the viewing permission can be avoided. In an example, for a first information unit for which the first user has the viewing permission, if the first information unit has the first label, the client of the first user may display the first information unit and the first label in the association manner. In this way, the first user may determine content of the first information unit according to the first label and the first information unit displayed in the association manner, and determine that the first information unit has the first label.

A schedule creating method is further provided according to an embodiment of the present disclosure, which is described below with reference to the accompanying drawings.

Reference is made to FIG. 20, which is a flowchart of a schedule creating method according to another embodiment of the present disclosure.

Similar to the schedule creating method shown in FIG. 18, the schedule creating method shown in FIG. 20 may be executed by the client or the server. In the following description of the embodiments of the present disclosure, the method being executed by the client is taken as an example for illustration.

The schedule creating method shown in FIG. 20 may include, for example, the following steps S2001-S2003.

In step S2001, a schedule adding page is displayed in response to a schedule adding operation triggered by a user on a page associated with a first label, where the schedule adding page includes the first label, and the page associated with the first label is configured to present associated information of the first label.

Step S2001 may refer to the description of step S1801 above, and no repeated description is made here.

In step S2002, the first label is modified to a second label in response to a label editing operation triggered by the user on the schedule adding page.

In an embodiment of the present disclosure, when the client displays a page associated with the first label, the user may further need to create a schedule with the second label. Therefore, in an example, the user may trigger a schedule adding operation on the page associated with the first label, and then the client may display a schedule adding page, and the schedule adding page includes the first label. Moreover, the first label may be modified. In an embodiment, the user may modify the first label to a second label by triggering a label editing operation.

Step S2002 may be implemented in multiple manners, and two possible implementations are introduced below.

The first implementation includes the following steps.

After the user triggers the label editing operation on the schedule adding page, the client may display at least one label candidate in response to the label editing operation. After the at least one label candidate is displayed, the user may trigger a selecting operation for one of the at least one label candidate. If the user triggers the selecting operation for the second label among the at least one label candidate, for example, clicks on the second label, the client may modify the first label to the second label.

It should be noted that, in consideration of the usage permission for the label, only when the user has the usage permission for a certain label, the user is allowed to add the label to information. Therefore, in an example, the user may have the usage permission for the at least one label candidate.

The second implementation includes the following steps.

After the user triggers the label editing operation on the schedule adding page, the client may display a character input area in response to the label editing operation. Then, the user may input a character in the character input area. The user may input at least a part of characters included in the second label, in the character input area. Correspondingly, after obtaining the character inputted by the user, the client may provide the user with one or more corresponding label candidates according to the character inputted by the user, and display the label candidates, so that the user may select the second label from the label candidates. The user selects the second label, that is, the user triggers the selecting operation for the second label among the label candidates. For example, the user clicks on the second label. Then, the client may modify the first label to the second label.

In step S2003: schedule information inputted by the user on the schedule adding page is obtained, and a schedule with the second label is generated.

After the schedule adding page is displayed, in addition to triggering the label editing operation, the user may input schedule information on the schedule adding page. The schedule information includes, for example, detailed information such as a subject of the schedule, start time and end time of the schedule, and a corresponding meeting room.

After the user inputs schedule information on the schedule adding page, the client may obtain the schedule information inputted by the user, and further generate a schedule with second label based on the obtained schedule information. It is to be understood that the generated schedule includes the schedule information obtained by the client.

In an example, after the schedule with the second label is created, summary information of the schedule may be presented on the schedule page of the second label.

With the schedule creating method shown in FIG. 20, when the user wants to create the schedule with the second label, even if a page displayed on the client is the page associated with the first label, the user does not need to switch the page displayed on the client to a page associated with the second label. Conversely, the schedule with the second label may be directly created on the page associated with the first label, thereby improving the operational flexibility of creating a schedule with a label.

Based on the method according to the above embodiments, an apparatus is further provided according to an embodiment of the present disclosure, which will be described below with reference to the accompanying drawings.

Reference is made to FIG. 21, which is a schematic structural diagram of a schedule creating apparatus according to an embodiment of the present disclosure. For example, the apparatus 2100 may include: a display unit 2101, a first obtaining unit 2102 and a generating unit 2103.

The display unit 2101 is configured to display a schedule adding page in response to a schedule adding operation triggered by a user on a page associated with a first label, where the schedule adding page includes the first label, and the page associated with the first label is configured to present associated information of the first label.

The first obtaining unit 2102 is configured to obtain schedule information inputted by the user on the schedule adding page.

The generating unit 2103 is configured to generate a schedule with the first label.

In an embodiment, the apparatus further includes: a second obtaining unit configured to obtain, in response to a label editing operation triggered by the user on the schedule adding page, a second label indicated by the label editing operation; and
the generating unit 2103 is configured to: generate a schedule with the first label and the second label.

In an embodiment, the user triggers the label editing operation through a label adding control.

In an embodiment, the second obtaining unit is configured to display at least one label candidate in response to the label editing operation triggered by the user on the schedule adding page, where the at least one label candidate includes the second label: and obtain the second label, in response to a selecting operation triggered by the user for the second label among the at least one label candidate.

In an embodiment, the second obtaining unit is configured to obtain a character inputted by the user in response to the label editing operation triggered by the user on the schedule adding page: and obtain the second label based on the character inputted by the user.

In an embodiment, the apparatus further includes: a first display unit configured to display summary information of the schedule in a schedule page corresponding to the second label, where the schedule page corresponding to the second label is configured to display the summary information of the schedule with the second label.

In an embodiment, the schedule addition page further includes: a participant of the schedule, where the participant of the schedule is a user having a viewing permission for the first label.

In an embodiment, the first obtaining unit 2102 is configured to obtain a participant of the schedule that is inputted by the user on the schedule adding page.

In an embodiment, the apparatus further includes: a permission setting unit configured to: in the case that the participant of the schedule that is inputted by the user on the schedule adding page does not have a permission for the first label before the schedule with the first label is generated, grant the permission for the first label to the participant of the schedule in response the generation of the schedule with the first label.

In an embodiment, the first label is shared among users that have the permission for the first label.

In an embodiment, the permission for the first label includes a usage permission, where a user having the usage permission for the first label is permitted to add the first label to an information unit on a client corresponding to the user.

In an embodiment, the permission for the first label includes a viewing permission, where associated information of the first label is displayed on a client of the user having the viewing permission for the first label.

In an embodiment, the apparatus further includes: a second display unit configured to display the first label and a first information unit on the client of a first user in an association manner, in response to the first user having the viewing permission for the first label, where the first user has a viewing permission for the first information unit.

In an embodiment, the page associated with the first label includes: an overview page of the first label, or a page corresponding to a schedule information field of the first label.

The overview page collectively displays information of respective information fields with the first label, or the page corresponding to the schedule information field is configured to display information of a schedule with the first label.

In an embodiment, the information of respective information fields is presented in different regions on the overview page.

The apparatus 2100 corresponds to the method provided in the above method embodiment corresponding to FIG. 18. Therefore, the implementation of the units of the apparatus 2100 is of the same conception as the method shown in FIG. 18 in the above method embodiment, and for the implementation of the units of the apparatus 2100, reference may be made to the relevant description of the above method embodiment and no repeated description is made here.

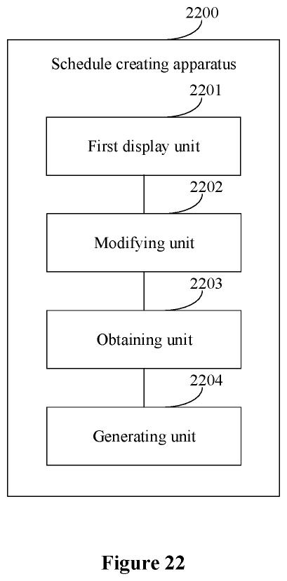

Reference is made to FIG. 22, which is a schematic structural diagram of a schedule creating apparatus according to another embodiment of the present disclosure. The apparatus 2200 may include, for example: a first display unit 2201, a modifying unit 2202, an obtaining unit 2203 and a generating unit 2204.

The first display unit 2201 is configured to display a schedule adding page in response to a schedule adding operation triggered by a user on a page associated with a first label, where the schedule adding page includes the first label, and the page associated with the first label is configured to present associated information of the first label.

The modifying unit 2202 is configured to modify the first label to a second label in response to a label editing operation triggered by the user on the schedule adding page.

The obtaining unit 2203 is configured to obtain schedule information inputted by the user on the schedule adding page.

The generating unit 2204 is configured to generate a schedule with the second label.

In an embodiment, the modifying unit 2202 is configured to: display at least one label candidate in response to the label editing operation triggered by the user on the schedule adding page, where the at least one label candidate includes the second label: and modify the first label to the second label in response to a selecting operation triggered by the user for the second label among the at least one label candidate.

In an embodiment, the modifying unit 2202 is configured to: obtain a character inputted by the user in response to the label editing operation triggered by the user on the schedule adding page: obtain the second label according to the character inputted by the user; and modify the first label to the second label.

In an embodiment, the apparatus further includes: a second display unit configured to display summary information of the schedule in a schedule page corresponding to the second label, where the schedule page corresponding to the second label is configured to display the summary information of the schedule with the second label.

The apparatus 2200 corresponds to the method provided in the above method embodiment corresponding to FIG. 20. Therefore, the implementation of the units of the apparatus 2200 is of the same conception as the method shown in FIG. 20 in the above method embodiment, and for the implementation of the units of the apparatus 2100, reference may be made to the relevant description of the above method embodiment and no repeated description is made here.

A device is further provided according to an embodiment of the present disclosure. The device includes a processor and a memory. The processor is configured to execute instructions stored in the memory, to cause the device executes the schedule creating method according to the above method embodiments.

A computer-readable storage medium including instructions is further provided according to an embodiment of the present disclosure. The instructions instruct a device to execute the schedule creating method according to the above method embodiments.

A computer program product is further provided according to an embodiment of the present disclosure. The computer program product, when running on a computer, causes the computer to execute the schedule creating method according to the above method embodiments.

The above are only preferred embodiments of the present disclosure and are illustrative of the technical principles applied in the present disclosure. It should be understood by those skilled in the art that the scope of the present disclosure is not limited to the above technical solutions formed by a specific combination of technical features, and also encompasses other technical solutions formed by any combination of the above technical features or equivalent features thereof, without departing from the inventive concept of the present disclosure, for example, technical solutions formed by replacing the above features and the technical features disclosed in present disclosure (but not limited to) with similar functions.

In addition, although the operations are depicted in a specific order, it should not be understood as these operations are required to be performed in the specific order shown or performed in a sequential order. Under certain circumstances, multitasking and parallel processing may be advantageous. Likewise, although several specific implementation details are included in the above discussion, these should not be construed as limiting the scope of the present disclosure. Certain features that are described in the context of separate embodiments can also be implemented in combination in a single embodiment. Conversely, various features described in the context of a single embodiment can also be implemented in multiple embodiments individually or in any suitable sub-combination.

Although the subject matter has been described in language specific to structural features and/or method logical actions, it should be understood that the subject matter defined in the appended claims is not necessarily limited to the specific features or actions described above. On the contrary, the specific features and actions described above are merely exemplary forms of implementing the claims.

1. An information interaction method, comprising:
receiving a label adding operation triggered by a user for a first object;
generating a first correspondence between a target label and the first object according to the label adding operation; and
generating a second correspondence between the target label and a second object, in response to a generation of the first correspondence, wherein the second object is associated with the first object.

2. The method according to claim 1, wherein the second object comprises at least one of:
a new object associated with the first object that is obtained after the label adding operation is received, and
a historically associated object of the first object obtained before the label adding operation is received.

3. (canceled)

4. The method according to claim 1, wherein the generating a second correspondence comprises:
generating the second correspondence according to the label adding operation, in response to determining that the user triggers to enable an automatic label adding function; or
generating the second correspondence, in response to a user set indicated by the first object having a permission to access the second object.

5. The method according to claim 1, further comprising:
determining that a label type of the target label in the second correspondence is an automatic addition type, according to the label adding operation.

6. The method according to claim 1, further comprising:
receiving a label adding operation triggered by a user for the second object, wherein the label adding operation triggered for the second object is used to add the target label to the second object; and
modifying a label type of the target label in the second correspondence to a manual addition type, according to the label adding operation triggered for the second object.

7-9. (canceled)

10. The method according to claim 1, wherein after the second correspondence is generated, the method further comprises:
displaying the first object and the second object on a label display interface of the target label.

11. The method according to claim 9, further comprising:
receiving a screening operation triggered by the user on a screening control of the label display interface, wherein the screening operation is used to screen out an object associated with the first object from objects with the target label; and
presenting the second object according to the screening operation.

12. The method according to claim 1, wherein the target label is visible to users within a preset sharing range, wherein the sharing range comprises at least two users.

13. The method according to claim 12, further comprising:
presenting the target label and the first object in an association manner to at least one of the at least two users in the sharing range, in response to the generation of the first correspondence; or presenting the target label and the second object in an association manner to at least one of the at least two users in the sharing range, in response to a generation of the second correspondence.

14. (canceled)

15. The method according to claim 1, further comprising:
deleting the second correspondence, in response to deleting the first correspondence, or releasing an association between the first object and the second object.

16. The method according to claim 1, further comprising:
deleting the second correspondence, in response to receiving a label deleting operation triggered by the user for the second object.

17. The method according to claim 1, further comprising:
modifying the target label in the second correspondence according to a label editing operation, in response to receiving the label editing operation triggered by the user for the second object.

18. The method according to claim 1, further comprising:
generating a third correspondence between the second object and a first label, in response to receiving a label adding operation triggered by the user for the second object, wherein the first label is added by using the label adding operation.

19. The method according to claim 1, wherein the first object and the second object comprises at least one of a folder, a cloud file, a local file, a schedule, a task, an instant messaging message and an instant messaging group.

20-21. (canceled)

22. The method according to claim 19, wherein the first object is the instant messaging group and the second object is an object associated with the instant messaging group, and wherein the object associated with the instant messaging group comprises at least one of an instant messaging Pin message, a cloud file and a local file.

23. (canceled)

24. The method according to claim 22, wherein the generating the second correspondence comprises:
generating the second correspondence according to the label adding operation, in response to the instant messaging group having a permission to access to the object associated with the instant messaging group.

25. (canceled)

26. The method according to claim 19, wherein the first object is the folder and the second object is an object associated with the folder, and wherein the object associated with the folder comprises a file and/or a folder belonging to the folder.

27. (canceled)

28. The method according to claim 19, wherein the first object is the schedule and the second object is an object associated with the schedule, and wherein the object associated with the schedule comprises at least one of a cloud file, a local file, a task, an instant messaging message and an instant messaging group message.

29. A label deleting method, comprising:
receiving a label deleting operation triggered by a user for a first object;
deleting a first correspondence between a target label and the first object, according to the label deleting operation; and
deleting a second correspondence between the target label and a second object, in response to a deletion of the first correspondence, wherein the second object is associated with the first object.

30. The method according to claim 29, wherein the second correspondence is generated based on a label adding operation for generating the first correspondence.

31-33. (canceled)

34. The method according to claim 29, wherein before the second correspondence is deleted, the method further comprises:
determining the second correspondence according to the first correspondence.

35. The method according to claim 34, wherein the deleting the second correspondence comprises:
deleting the second correspondence according to the label deleting operation triggered by the user for the first object, in response to a label type of the target label in the second correspondence being an automatic addition type.

36. The method according to claim 29, further comprising:
retaining a third correspondence between the target label and a third object associated with the first object, in response to the deletion of the first correspondence and a label type of the target label in the third correspondence being a manual addition type.

37. The method according to claim 29, wherein the deleting the second correspondence comprises:
deleting the second correspondence, in response to the second object being associated with at least one object other than the first object in a target object set, and in response to receiving a label deleting operation triggered for each of the at least one object, wherein the target object set comprises at least one object with the target label.

38. (canceled)

39. The method according to claim 29, wherein the deleting the second correspondence according to the label deleting operation triggered by the user for the first object comprises:
deleting the second correspondence according to the label deleting operation, in response to the second object being not associated with any object except the first object in the target object set, wherein the target object set includes an object with the target label.

40. The method according to claim 29, further comprising:
deleting the second correspondence, in response to releasing an association relationship between the first object and the second object.

41. The method according to claim 40, wherein the deleting the second correspondence comprises:
deleting the second correspondence, in response to the second object being associated with at least one object other than the first object in the target object set, and in response to receiving the label deleting operation triggered by the user for each of the at least one object, wherein target object set comprises an object with the target label.

42. The method according to claim 40, wherein the deleting the second correspondence comprises:
deleting the second correspondence, in response to the second object being associated with at least one object other than the first object in the target object set, and in response to releasing an association relationship between each of the at least one object and the second object, wherein target object set comprises at least one object with the target label; or
deleting the second correspondence, in response to the second object being not associated with any object except the first object in the target object set, wherein the target object set includes an object with the target label.

43-44. (canceled)

45. The method according to claim 29, wherein the first object and the second object comprises at least one of a folder, a cloud file, a local file, a schedule, a task, an instant messaging message and an instant messaging group.

46-109. (canceled)

110. A device, comprising a processor and a memory, wherein
the processor is configured to execute instructions stored in the memory, to cause the device to: receive a label adding operation triggered by a user for a first object, generate a first correspondence between a target label and the first object according to the label adding operation; and generate a second correspondence between the target label and a second object, in response to a generation of the first correspondence, wherein the second object is associated with the first object; or
receive a label deleting operation triggered by a user for a first object; delete a first correspondence between a target label and the first object, according to the label deleting operation; and delete a second correspondence between the target label and a second object, in response to a deleting of the first correspondence, wherein the second object is associated with the first object.

111. A non-transitory computer-readable storage medium comprising instructions, wherein the instructions instruct a device to:
receive a label adding operation triggered by a user for a first object, generate a first correspondence between a target label and the first object according to the label adding operation; and generate a second correspondence between the target label and a second object, in response to a generation of the first correspondence, wherein the second object is associated with the first object; or
receive a label deleting operation triggered by a user for a first object; delete a first correspondence between a target label and the first object, according to the label deleting operation; and delete a second correspondence between the target label and a second object, in response to a deleting of the first correspondence, wherein the second object is associated with the first object.

112. (canceled)
